(19) United States
(12) Patent Application Publication
(10) Pub. No.: US 2017/0083827 A1
(43) Pub. Date: Mar. 23, 2017

(54) Data-Driven Accelerator For Machine Learning And Raw Data Analysis

(71) Applicant: QUALCOMM Incorporated, San Diego, CA (US)

(72) Inventors: Behnam Robatmili, San Jose, CA (US); Matthew Leslie Badin, San Jose, CA (US); Dario Suárez Gracia, Teruel (ES); Gheorghe Calin Cascaval, Palo Alto, CA (US); Nayeem Islam, Palo Alto, CA (US)

(21) Appl. No.: 14/862,408

(22) Filed: Sep. 23, 2015

(51) Int. Cl. G06N 99/00

(52) U.S. Cl. CPC G06N 99/005

(57) ABSTRACT

Embodiments include computing devices, apparatus, and methods implemented by the apparatus for accelerating machine learning on a computing device. Raw data may be received in the computing device from a raw data source device. The apparatus may identify key features as two dimensional matrices of the raw data such that the key features are mutually exclusive from each other. The key features may be translated into key feature vectors. The computing device may generate a feature vector from at least one of the key feature vectors. The computing device may receive a first partial output resulting from an execution of a basic linear algebra subprogram (BLAS) operation using the feature vector and a weight factor. The first partial output may be combined with a plurality of partial outputs to produce an output matrix. Receiving the raw data on the computing device may include receiving streaming raw data.

### BACKGROUND

Most machine learning accelerators reformat learning algorithms to define them as matrix or vector dot product operations and then execute the machine learning using basic linear algebra subprograms (BLAS). While this approach can be considered fast, it does not reduce all of the overhead associated with data translation or data movement starting from raw data and feature extraction. Before doing machine learning or BLAS, the raw data must be read, stored, and translated to extract features needed for the machine learning or BLAS operations. Extracting key features from the stored data requires multiple memory access to retrieve the stored data and to store the extracted key features. Key features are often derived from overlapping data sets resulting in multiple memory accesses for duplicate copies of data. Thus, reformatting learning algorithms to define them as matrix or vector dot product operations and then execute the machine learning using BLAS is still inefficient given the large amount of data movement in and out of memory required before such accelerated learning is applied to the data.

### SUMMARY

The methods and apparatuses of various embodiments provide circuits and methods for accelerating machine learning on a computing device. In various embodiments, the methods may include receiving raw data from a raw data source device, identifying key features as two dimensional matrices of the raw data such that the key features are mutually exclusive from each other, translating the key features into key feature vectors, generating a feature vector from at least one of the key feature vectors, receiving a first partial output resulting from an execution of a basic linear algebra subprogram (BLAS) operation using the feature vector and a weight factor, and combining the first partial output with a plurality of partial outputs to produce an output matrix.

In some embodiments, identifying key features as two dimensional matrices of the raw data such that the key features are mutually exclusive from each other may include identifying a first key feature as a first two dimensional matrix of a designated size, and identifying a second key feature as a second two dimensional matrix of the designated size a designated number of units from the first key feature.

In some embodiments, generating a feature vector from at least one of the key feature vectors may include selecting a top key feature vector from a key feature vector queue, and using the top key feature vector as the feature vector.

In some embodiments, generating a feature vector from at least one of the key feature vectors may include selecting a top key feature vector from a key feature vector queue, selecting a next key feature vector from the key feature vector queue, selecting top key feature vector positions and next key feature vector positions, and combining the selected top key feature vector position and the selected next key feature vector positions into the feature vector. In some embodiments, selecting top key feature vector positions and next key feature vector positions may include selecting the top key feature vector positions and the next key feature vector positions such that each of the selected top key feature vector position and the selected next key feature vector positions represent mutually exclusive locations from each other in the raw data and represent an unidentified key feature of raw data that spans a plurality of the identified key features of the raw data, and combining the selected top key feature vector position and the selected next key feature vector positions into the feature vector may include combining the selected top key feature vector position and the selected next key feature vector positions into the feature vector such that the feature vector is configured like a key feature vector of the unidentified key feature.

Some embodiments may further include activating a set of vector units upon receiving the raw data at a feature buffer associated with the set of vector units, in which the set of vector units is mapped to the output matrix, executing the BLAS operation by each vector unit of the set of vector units, and outputting at least one partial output by each vector unit. Some embodiments may further include determining whether any feature vectors remain for use in an execution of the BLAS operation by the set of vector units, and deactivating the set of vector units in response to determining that no feature vectors remain for use in an execution of the BLAS operation by the set of vector units.

In some embodiments, receiving raw data from a raw data source device may include receiving streaming raw data from the raw data source device.

Various embodiments may include an apparatus configured to accelerate machine learning on a computing device. The apparatus may include a raw data source device, and a vectorization unit communicatively connected to the raw data source and configured to perform operations of one or more embodiment methods described above.

Various embodiments may include an apparatus configured to accelerate machine learning on a computing device. The apparatus may include means for performing functions of one or more of the aspect methods described above.

Various embodiments may include a non-transitory processor-readable storage medium having stored thereon processor-executable instructions to cause a processor of a computing device to perform operations of the methods described above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1 is a component block diagram illustrating a computing device suitable for implementing an embodiment.

FIG. 2 is a component block diagram illustrating an example multi-core processor suitable for implementing an embodiment.

FIG. 3 is a component block diagram illustrating an example machine learning accelerator suitable for implementing an embodiment.

FIG. 4 is a component block diagram illustrating an example machine learning accelerator suitable for implementing an embodiment.

FIG. 5 is a component block diagram illustrating an example feature buffer suitable for implementing an embodiment.

FIG. 6 is a component block diagram illustrating an example feature generator suitable for implementing an embodiment.

FIG. 7 is a process flow diagram illustrating an embodiment method for implementing acceleration of machine learning and raw data analysis.

FIG. 8 is a process flow diagram illustrating an embodiment method for accelerating machine learning and raw data analysis.

FIG. 9 is a process flow diagram illustrating an embodiment method for extracting a key feature vector from raw data.

FIG. 10 is a process flow diagram illustrating an embodiment method for generating a feature from a key feature vector(s).

FIG. 11 is a process flow diagram illustrating an embodiment method for combining a top key feature vector and a next key feature vector as a feature.

FIGS. 12A-12G are schematic diagrams illustrating an example of a process flow for extracting a key feature vector from raw data and generating a feature vector from the key feature vector for implementing an embodiment.

FIG. 13 is a component block diagram illustrating an example vector unit suitable for implementing an embodiment.

FIG. 14 is a process flow diagram illustrating an embodiment method for generating a partial output of a processed raw data.

FIG. 15 is a component block diagram illustrating an example vector unit suitable for implementing an embodiment.

FIG. 16 is a process flow diagram illustrating an embodiment method for generating a partial output of a processed raw data.

FIGS. 17A-17D are schematic diagrams illustrating an example of a process flow for generating a kernel using filtered raw data.

FIGS. 18A-18D are schematic diagrams illustrating an example of a process flow for generating a pre-partial output using a kernel and a feature vector.

FIG. 19 is a schematic diagram illustrating an example of a process flow for generating a feature vector using an arbiter to assign addresses to raw data.

FIG. 20 is component block diagram illustrating an example mobile computing device suitable for use with the various embodiments.

FIG. 21 is component block diagram illustrating an example mobile computing device suitable for use with the various embodiments.

FIG. 22 is component block diagram illustrating an example server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

The terms “computing device” and “mobile computing device” are used interchangeably herein to refer to any one or all of cellular telephones, smartphones, personal or mobile multi-media players, personal data assistants (PDA's), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, and a multi-core programmable processor. While the various embodiments are particularly useful for mobile computing devices, such as smartphones, which have limited memory and battery resources, the embodiments are generally useful in any electronic device that implements a plurality of memory devices and a limited power budget in which reducing the power consumption of the processors can extend the battery-operating time of a mobile computing device. The term “computing device” may further refer to stationary computing devices including personal computers, desktop computers, all-in-one computers, work stations, super computers, mainframe computers, embedded computers, servers, home theater computers, and game consoles.

Embodiments include methods, and systems and devices implementing such methods for improving learning algorithm performance by implementing hardware accelerated machine learning and raw data analysis using a data vectorization unit for traversal of raw data, extracting key feature vectors, and generating features vectors, and a two-dimensional array of vector units for performing matrix multiplication or vector dot products of machine learning algorithms using the feature vectors and weight (kernel) vectors.

The data vectorization unit may include multiple feature buffers and an output buffer. Each feature buffer may include a key feature translator, a key feature queue, and a feature generator for pre-processing data prior to applying machine learning on the data. Each feature buffer may interface with multiple raw data source devices, including a raw data storage device or a sensor.

Raw data received by a feature buffer may be provided to the key feature translator for extraction of key feature vectors from the raw data for use in creating feature vectors. The feature translator may read the raw data in a traversal order or as the raw data arrives. The key feature vectors may be extracted in multiple manners depending on what data is useful for the machine learning. The useful data may be extracted and serialized as key feature vectors from the raw data, and the remaining raw data may be discarded. The key feature vectors may include only enough of the useful data for the machine learning such that the key feature vectors may be used for generating feature vectors for the machine learning, for example by interpolation, without including duplicate useful data in the key feature vectors.

The key feature vectors may be queued in a key feature queue from which the feature generator may receive the key feature vectors for generating the feature vectors. The key feature queue may be a first-in first-out queue or a circular queue. In an embodiment, a first key feature vector in the key feature queue may represent a first feature vector, and the feature generator may output the first feature vector.

In an embodiment, the feature generator may construct a second feature vector from a combination of the data from the first key feature vector and data from a second key feature vector, and output the second feature vector.

An array of vector units, topologically mapped to an output matrix, may receive the feature vectors from and provide the output matrix to the data vectorization unit. Each vector unit may include a weight buffer, a process unit, and a partial output buffer. A set of vector units may be associated with a feature buffer, and the set of vector units may receive the feature vectors from the associated feature buffer. The vector units may also receive a weight vector, which may be provided from memory, and store the weight vector in the weight buffer. The process unit is arranged to implement a vector function (e.g., a sigmoid function, multiply-accumulate operation, etc.) using the received feature vector, the weight vector, and/or the feature vector altered by the weight factor. Partial outputs of the process unit may be stored in the partial output buffer until the complete output from processing the feature vector is output to the output buffer or back to the feature buffers of the data vectorization unit. The complete output from each vector unit may represent a portion of an output matrix.

The data received by the feature buffer may be streamed from the raw data source device to the feature buffer, even while the data continue to be collected by the raw data source device. The components of the data vectorization unit and the array of vector units may operate on their respective inputs concurrently. For each component of the data vectorization unit and the vector units, an input may trigger a respective operation.

The key feature translator may continually extract and output key feature vectors from the streaming data. The key feature queue may continually retain the key feature vectors and provide the key feature vectors to the feature generator. The feature generator may continually construct and output the feature vectors. The vector units may continually process the feature vectors and output portions of the output matrix until there is no streaming data, key feature vectors, or feature vectors remaining. In response to a lack of streaming data and no activity of an associated set of components in the data vectorization unit and the array of vector units, the data vectorization unit and/or array of vector units may enter or partially enter a low power idle state, powering down some components.

The data vectorization unit and the array of vector units in hardware may be arranged so that streaming data may be operated on to perform raw data analysis and machine learning in a just-in-time/data-flow manner, where there is no need to wait for a full set of data from a data recording event. Thus, the various embodiments enable more efficient use of resources by eliminating multiple memory access operations for retrieving raw data and storing pre-processed data, and central processing unit (CPU) operations for pre-processing the raw data. The manner in which the key feature vectors are extracted and the feature vectors are generated further reduces resource usage by avoiding memory accesses and CPU operations for duplicate data.

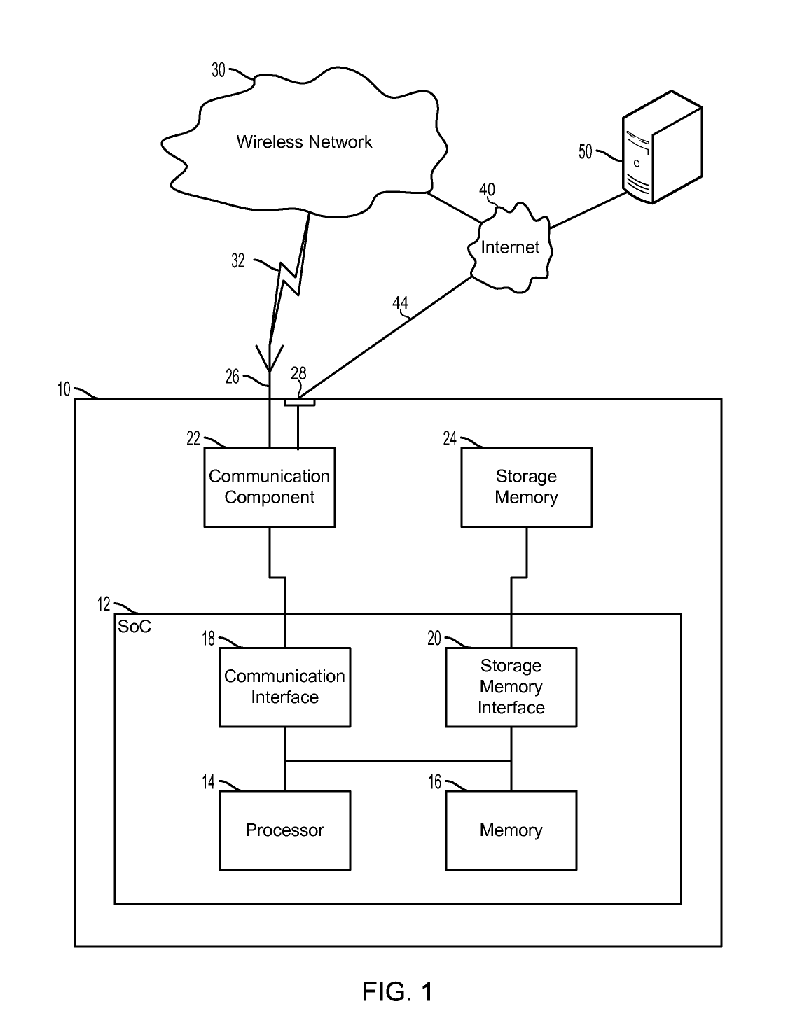

FIG. 1 illustrates a system including a computing device 10 in communication with a remote computing device 50 suitable for use with the various embodiments. The computing device 10 may include a system-on-chip (SoC) 12 with a processor 14, a memory 16, a communication interface 18, and a storage memory interface 20. The computing device may further include a communication component 22 such as a wired or wireless modem, a storage memory 24, an antenna 26 for establishing a wireless connection 32 to a wireless network 30, and/or the network interface 28 for connecting to a wired connection 44 to the Internet 40. The processor 14 may include any of a variety of hardware cores, for example a number of processor cores.

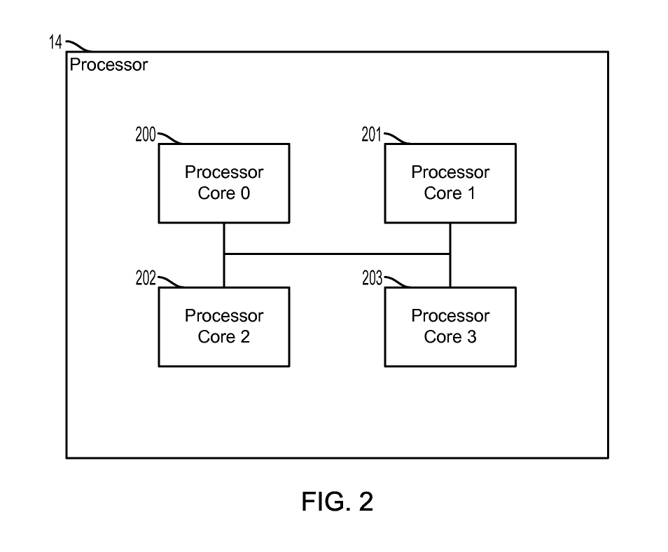

The term “system-on-chip” (SoC) is used herein to refer to a set of interconnected electronic circuits typically, but not exclusively, including a hardware core, a memory, and a communication interface. A hardware core may include a variety of different types of processors, such as a general purpose processor, a central processing unit (CPU), a digital signal processor (DSP), a graphics processing unit (GPU), an accelerated processing unit (APU), an auxiliary processor, a single-core processor, and a multi-core processor. A hardware core may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon. The SoC 12 may include one or more processors 14. The computing device 10 may include more than one SoCs 12, thereby increasing the number of processors 14 and processor cores. The computing device 10 may also include processors 14 that are not associated with an SoC 12. Individual processors 14 may be multi-core processors as described below with reference to FIG. 2. The processors 14 may each be configured for specific purposes that may be the same as or different from other processors 14 of the computing device 10. One or more of the processors 14 and processor cores of the same or different configurations may be grouped together. A group of processors 14 or processor cores may be referred to as a multi-processor cluster.

The memory 16 of the SoC 12 may be a volatile or non-volatile memory configured for storing data and processor-executable code for access by the processor 14. The computing device 10 and/or SoC 12 may include one or more memories 16 configured for various purposes. In an embodiment, one or more memories 16 may include volatile memories such as random access memory (RAM) or main memory, or cache memory. These memories 16 may be configured to temporarily hold a limited amount of data received from a data sensor or subsystem, data and/or processor-executable code instructions that are requested from non-volatile memory, loaded to the memories 16 from non-volatile memory in anticipation of future access based on a variety of factors, and/or intermediary processing data and/or processor-executable code instructions produced by the processor 14 and temporarily stored for future quick access without being stored in non-volatile memory.

The memory 16 may be configured to store data and processor-executable code, at least temporarily, that is loaded to the memory 16 from another memory device, such as another memory 16 or storage memory 24, for access by one or more of the processors 14. The data or processor-executable code loaded to the memory 16 may be loaded in response to execution of a function by the processor 14. Loading the data or processor-executable code to the memory 16 in response to execution of a function may result from a memory access request to the memory 16 that is unsuccessful, or a miss, because the requested data or processor-executable code is not located in the memory 16. In response to a miss, a memory access request to another memory 16 or storage memory 24 may be made to load the requested data or processor-executable code from the other memory 16 or storage memory 24 to the memory device 16. Loading the data or processor-executable code to the memory 16 in response to execution of a function may result from a memory access request to another memory 16 or storage memory 24, and the data or processor-executable code may be loaded to the memory 16 for later access.

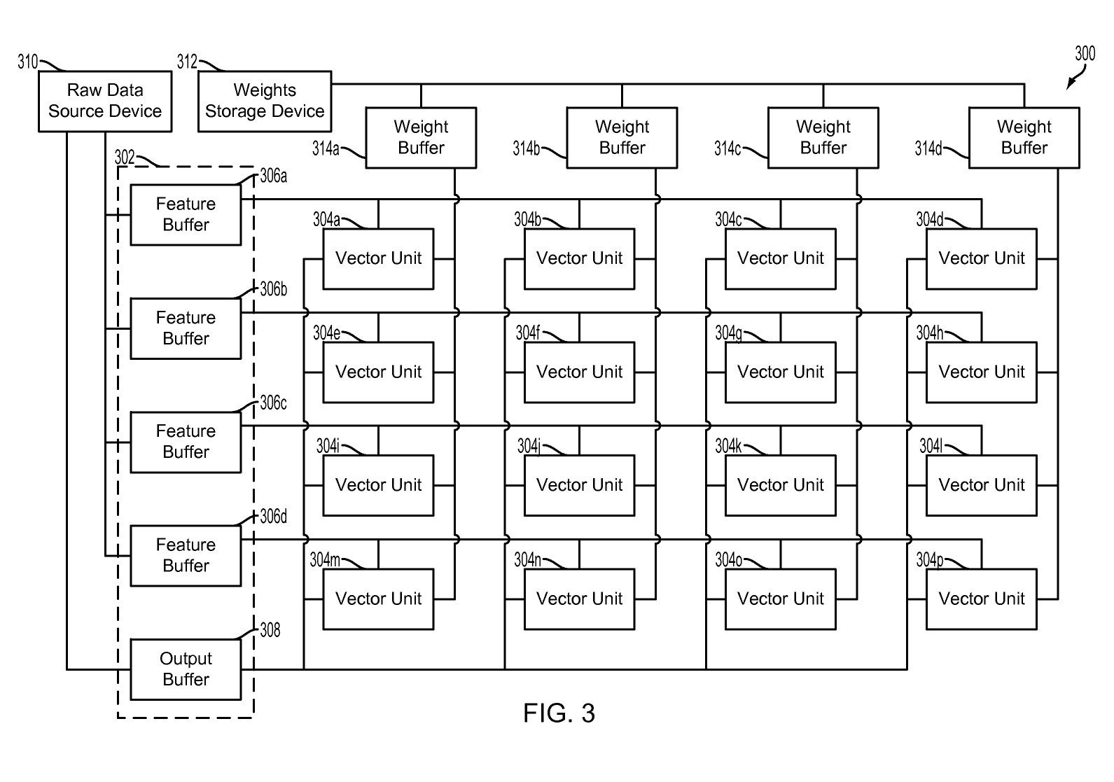

In an embodiment, the memory 16 may be configured to store raw data, at least temporarily, that is loaded to the memory 16 from a raw data source device, such as a sensor or subsystem. Raw data may stream from the raw data source device to the memory 16 and be stored by the memory until the raw data can be received and processed by a machine learning accelerator as discussed further herein with reference to FIGS. 3-19.

The communication interface 18, communication component 22, antenna 26, and/or network interface 28, may work in unison to enable the computing device 10 to communicate over a wireless network 30 via a wireless connection 32, and/or a wired network 44 with the remote computing device 50. The wireless network 30 may be implemented using a variety of wireless communication technologies, including, for example, radio frequency spectrum used for wireless communications, to provide the computing device 10 with a connection to the Internet 40 by which it may exchange data with the remote computing device 50.

The storage memory interface 20 and the storage memory 24 may work in unison to allow the computing device 10 to store data and processor-executable code on a non-volatile storage medium. The storage memory 24 may be configured much like an embodiment of the memory 16 in which the storage memory 24 may store the data or processor-executable code for access by one or more of the processors 14. The storage memory 24, being non-volatile, may retain the information even after the power of the computing device 10 has been shut off. When the power is turned back on and the computing device 10 reboots, the information stored on the storage memory 24 may be available to the computing device 10. The storage memory interface 20 may control access to the storage memory 24 and allow the processor 14 to read data from and write data to the storage memory 24.

Some or all of the components of the computing device 10 may be differently arranged and/or combined while still serving the necessary functions. Moreover, the computing device 10 may not be limited to one of each of the components, and multiple instances of each component may be included in various configurations of the computing device 10.

FIG. 2 illustrates a multi-core processor 14 suitable for implementing an embodiment. The multi-core processor 14 may have a plurality of homogeneous or heterogeneous processor cores 200, 201, 202, 203. The processor cores 200, 201, 202, 203 may be homogeneous in that, the processor cores 200, 201, 202, 203 of a single processor 14 may be configured for the same purpose and have the same or similar performance characteristics. For example, the processor 14 may be a general purpose processor, and the processor cores 200, 201, 202, 203 may be homogeneous general purpose processor cores. Alternatively, the processor 14 may be a graphics processing unit or a digital signal processor, and the processor cores 200, 201, 202, 203 may be homogeneous graphics processor cores or digital signal processor cores, respectively. For ease of reference, the terms “processor” and “processor core” may be used interchangeably herein.

The processor cores 200, 201, 202, 203 may be heterogeneous in that, the processor cores 200, 201, 202, 203 of a single processor 14 may be configured for different purposes and/or have different performance characteristics. The heterogeneity of such heterogeneous processor cores may include different instruction set architecture, pipelines, operating frequencies, etc. An example of such heterogeneous processor cores may include what are known as “big.LITTLE” architectures in which slower, low-power processor cores may be coupled with more powerful and power-hungry processor cores. In similar embodiments, the SoC 12 may include a number of homogeneous or heterogeneous processors 14.

In the example illustrated in FIG. 2, the multi-core processor 14 includes four processor cores 200, 201, 202, 203 (i.e., processor core 0, processor core 1, processor core 2, and processor core 3). For ease of explanation, the examples herein may refer to the four processor cores 200, 201, 202, 203 illustrated in FIG. 2. However, the four processor cores 200, 201, 202, 203 illustrated in FIG. 2 and described herein are merely provided as an example and in no way are meant to limit the various embodiments to a four-core processor system. The computing device 10, the SoC 12, or the multi-core processor 14 may individually or in combination include fewer or more than the four processor cores 200, 201, 202, 203 illustrated and described herein.

FIG. 3 illustrates an example machine learning accelerator 300 suitable for implementing an embodiment. The machine learning accelerator 300, which is also referred to as an apparatus herein, may include a data vectorization unit 302 and an array of vector units 304 (e.g., 304a-304p). The machine learning accelerator 300 may include or be connected to a raw data source device 310, a weight storage device 312, and a number of weight buffers 314 (e.g., 314a-314d). The machine learning accelerator 300 may be configured to accelerate the processing of raw data by vectorizing the raw data into feature vectors of the raw data and performing matrix multiplication or vector dot products of machine learning algorithms. The composition of the components of the machine learning accelerator 300 may differ depending on various factors, including the machine learning algorithms implemented, the size and/or complexity of the raw data, and the power and/or performance requirements of the computing device.

The data vectorization unit 302 may include a number of feature buffers 306 (e.g., 306a-306d) and at least one output buffer 308. The raw data source device 310 may provide raw data to the data vectorization unit 302. In an embodiment, the raw data may be streamed from the raw data source device 310 to the data vectorization unit 302. Streaming the raw data may include continually providing the raw data to the data vectorization unit 302 as the raw data is acquired or close in time thereafter by the raw data source device 310. For example, the raw data source device 310 may be a video capture device that may stream raw video data as it is captured by the video capture device. The raw data source device 310 may similarly be any device capable of acquiring data relating to an input in real-time or near real-time, such as at least one of an audio sensor, an electromagnetic radiation sensor, chemical sensor, temperature sensor, etc. In another example, the raw data source device 310 may be a fast memory, such as a cache memory, random access memory, or other solid state memory device, connected to a sensor and receiving the raw data from the sensor. The fast memory may provide the raw data to the data vectorization unit 302 as the raw data is acquired or close in time thereafter. In an embodiment, the fast memory may store the raw data and provide it to the data vectorization unit 302 in a streaming or as needed manner.

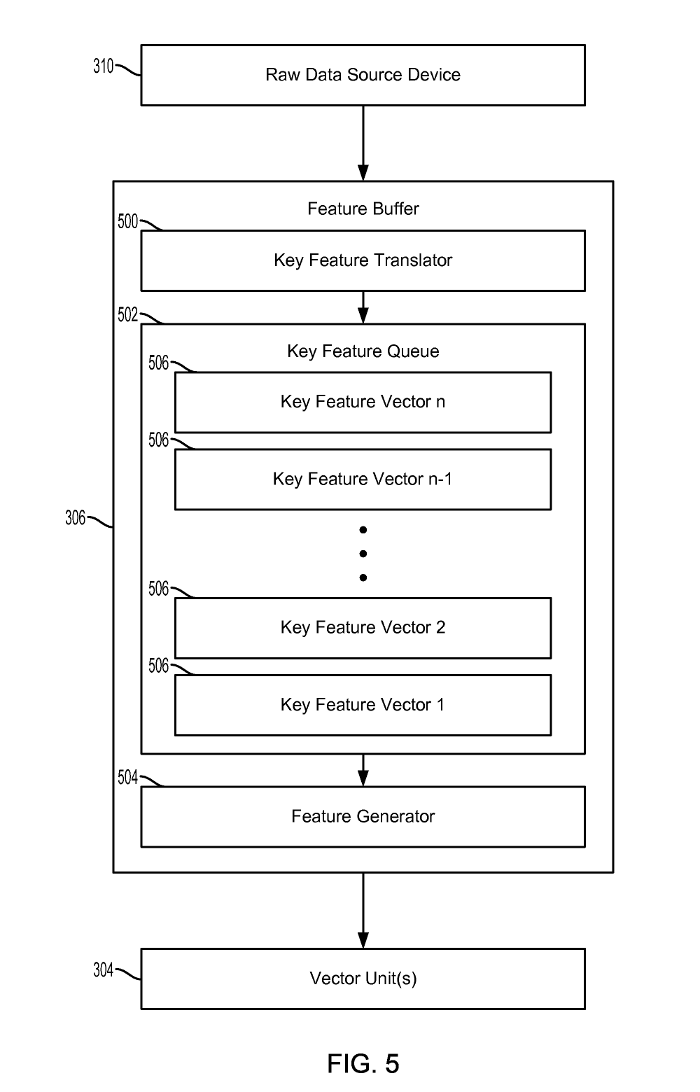

The data vectorization unit 302 may receive the raw data at the feature buffers 306. Various combinations of feature buffers 306 may be used to receive the raw data (e.g., feature buffer 306a; feature buffers 306a and 306b; feature buffers 306a-306c; or feature buffers 306a-306d). The feature buffers 306 may receive the raw data and extract feature vectors from the raw data, discussed further herein with reference to FIGS. 5, 6, and 8-12G. Each feature buffer 306 may be activated or inactivated depending on whether there is raw data available for the feature buffer 306. The number of feature buffers 306 included in the data vectorization unit 302 may depend on various factors, including the machine learning algorithms implemented, the size and/or complexity of the raw data, and the power and/or performance requirements of the computing device.

The feature buffers 306 may output the feature vectors to the array of vector units 304. Each feature buffer 306 may be associated with a set of the array of vector units 304. In an embodiment, the each feature buffer 306 may be associated with a row of the array of vector units 304 (e.g., feature buffer 306a may be associated with vector units 304a-304d; feature buffer 306b may be associated with vector units 304e-304h; feature buffer 306c may be associated with vector units 304i-304l; and feature buffer 306d may be associated with vector units 304m-304p). The array of vector unit 304 may be topologically mapped to an output matrix representing the structure of the output data from the machine learning algorithms used to process the raw data. The feature vectors received from the feature buffers 306 may represent portions of the raw data matching locations in the raw data with locations in the output matrix for the processed data. Respective feature vectors may be received by the vector units 304 from their associated feature buffer 306. In the example in which a row of vector units 304 is associated with a particular feature buffer 306, each feature buffer in the row of vector units 304 may receive the same feature vector or a respective portion of the feature vector.

Weight factors may be used by the vector units 304 to modify the values of the feature vectors. In an embodiment, a weights storage device 312 may be any type of volatile or non-volatile storage device, and may store the weight factors for modifying the feature vectors. The weight factors may be retrieved from the weight storage device 312 and received by the weight buffers 314. The vector units 304 may be connected to or include a weight buffer 314 associated with the vector unit 304. In an example, a dedicated weight buffer 314 may be associated with a column of the array of vector units 304 (e.g., weight buffer 314a may be associated with vector units 304a, 304e, 304i, and 304m; weight buffer 314b may be associated with vector units 304b, 304f, 304j, and 304n; weight buffer 314c may be associated with vector units 304c, 304g, 304k, and 304o; and weight buffer 314d may be associated with vector units 304d, 304h, 304l, and 304p). The weight factors received by each weight buffer 314 may be the same weight factors for all of the vector units 304 associated with a respective weight buffer 314, or the weight factors may vary for different vector units 304 associated with a respective weight buffer 314.

The vector units 304 may be configured to perform a vector function (e.g., a sigmoid function, multiply-accumulate operation, etc.) on the feature vectors, either using the feature vector as received or as modified by the weight factor. The vector function performed by the vector units 304 may vary depending on the type of data analysis and machine learning. Operating on the feature vectors by the vector units 304 allows the machine learning accelerator 300 to execute the machine learning using basic linear algebra subprograms. The resulting output of each vector unit 304 is a partial output of the output matrix for the array of vector units 304. Each vector unit 304 and weight buffer 314 may be activated or deactivated depending on whether there is raw data available for an associated feature buffer 306 or a feature vector for the vector unit 304. Activation/deactivation of the vector units 304 and weight buffers 314 may also depend on the size of the feature vectors. The number of vector units 304 and weight buffers 314 may depend on various factors, including the machine learning algorithms implemented, the size and/or complexity of the raw data, and the power and/or performance requirements of the computing device.

The output matrix may represent a matrix multiplication or vector dot product of the feature vectors and the weights. The partial outputs of the vector units 304 may be output to the output buffer 308 of the data vectorization unit 302. The output buffer 308 may temporarily store the partial output until the output matrix for a portion of the raw data is completed, and output the output matrix to a processor 14, subsystem, or memory 16, 24 of the computing device 10 (reference FIG. 1), or may output the output matrix to the feature buffers 306 for further processing. The machine learning accelerator 300 may continually produce output matrices in response to receiving the raw data.

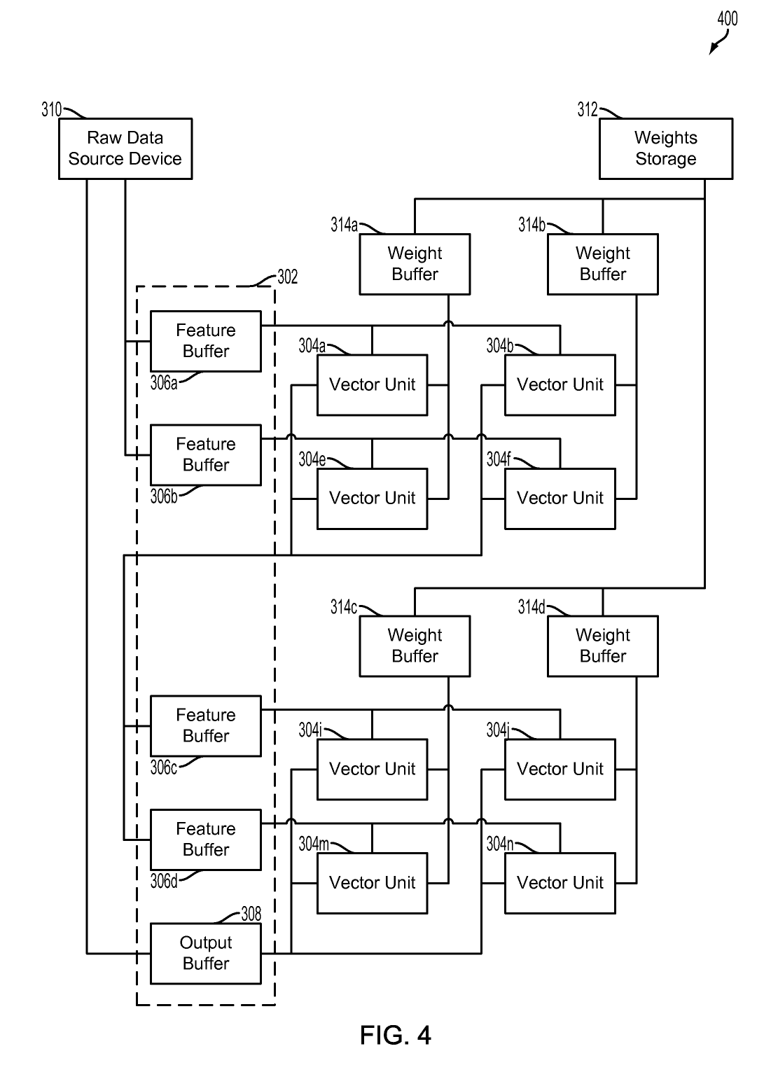

FIG. 4 illustrates an example machine learning accelerator 400 (also referred to as an apparatus herein) suitable for implementing an embodiment. The machine learning accelerator 400 may be implemented in a variety of configurations depending on various factors, including the machine learning algorithms implemented, the size and/or complexity of the raw data, the power and/or performance requirements of the computing device, and the processing requirements for the raw data. In an example illustrated in FIG. 4, the machine learning accelerator 400 may include similar components to the example illustrated in FIG. 3, including the data vectorization unit 302, the vector units 304 (e.g., 304a, 304b, 304e, 304f, 304i, 304j, 304m, and 304n). The machine learning accelerator 300 may also include or be connected to the raw data source device 310, the weight storage device 312, and the weight buffers 314 (e.g., 314a-314d). In an embodiment, the raw data may require multiple iteration machine learning processing before the output matrix may be completed. The example in FIG. 4 illustrates a two iteration machine learning process. In this example, the feature vectors produced by feature buffers 306a, 306b are operated on by the vector units 304a, 304b, 304e, 304f. The partial output of the vector units 304a, 304b, 304e, 304f may be fed to the feature buffers 306c, 306d, rather than to the output buffer 308 as in the example illustrated in FIG. 3. The feature buffers 306c, 306d may produce further feature vectors from the partial outputs of the vector units 304a, 304b, 304e, 304f. The feature vectors produced from the partial outputs may be operated on by the vector units 304i, 304j, 304m, and 304n, which may produce further partial outputs that are used to produce the output matrix in the output buffer 308.

FIG. 5 illustrates an example feature buffer 306 suitable for implementing an embodiment. The feature buffer 306 may include a key feature translator 500, a key feature queue 502 and a feature generator 504. As in the other examples described herein, the feature buffer 306 may be connected to the raw data source device 310, and receive raw data on a streaming or as needed basis from the raw data source device 310. The key feature translator 500 may extract key feature vectors from the raw data for use in generating the feature vectors. The key feature vectors may include portions of raw data, or key features, that are sized based on feature vector requirements for implementing the machine learning. In other words, the size of a key feature vector may match the size of the feature vector used in the vector operations of the vector units. The portions of raw data, or key features, used to produce the key feature vectors may be determined by a set of parameters provided based on the machine learning implemented by the machine learning accelerator. In an embodiment, the key feature vector parameters may include a size parameter and a stride parameter. The size parameter may determine a size of a matrix of raw data, or key features, to use for producing the key feature vectors, and may depend on a type of machine learning, a granularity for processing the raw data, and/or a number and capability of the vector units of the machine learning accelerator. The stride parameter may determine a movement of the matrix in the raw data, or key features, for producing the key feature vectors. The stride parameter may be set such that the selections of raw data, or key features, for the key feature vectors do not overlap, or are mutually exclusive from each other. The key feature translator 500 may extract the key feature vectors from the raw data as it receives the raw data and output the key feature vectors to the key feature queue 502.

The key feature queue 502 may be configured to temporarily store the key feature vectors 506. The key feature queue 502 may be a first-in first-out queue or a circular queue configured to store “n” key feature vectors 506. The key feature vectors 506 may be received by the key feature queue 502 as they are extracted from the raw data by the key feature translator 500. A key feature vector 506 (e.g., key feature vector 1) at the top of the key feature queue 502 may be output to the feature generator 504. In an embodiment, the key feature vector 506 output to the feature generator 504 may be discarded or overwritten so that a next key feature vector 506 (e.g., key feature vector 2) may be moved to the top of the key feature queue 502, the remaining key feature vectors 506 may be shifted up in the key feature queue 502, and a new key feature vector 506 may be written to the bottom of the key feature queue 502.

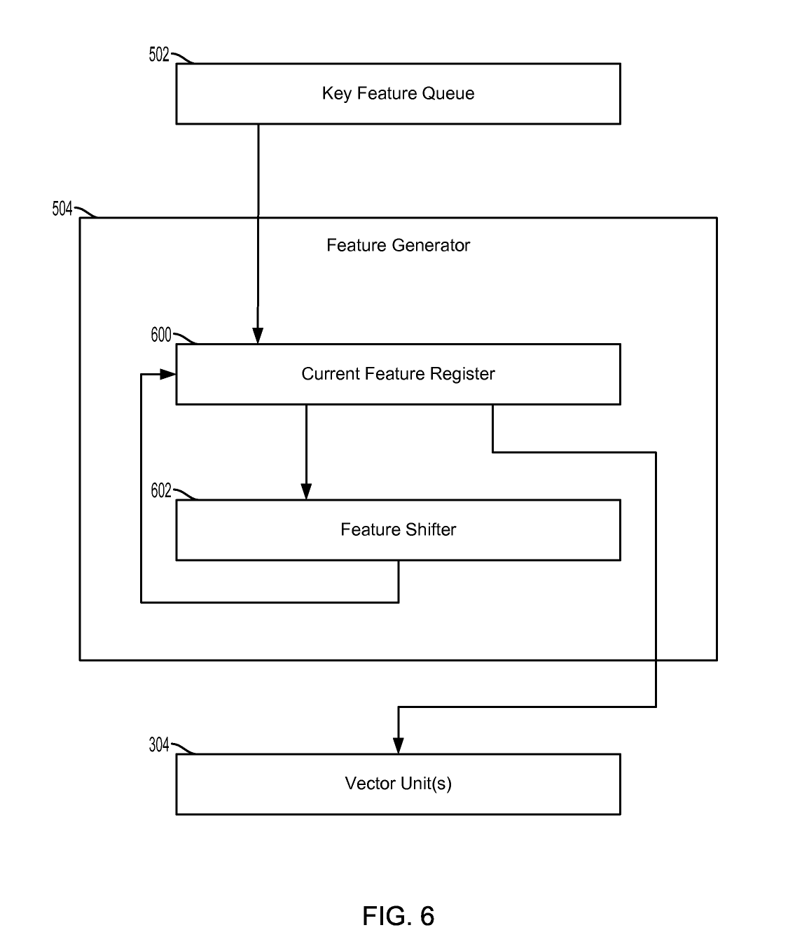

The feature generator 504 may receive a key feature vector 506 from the key feature queue 502 and generate a feature vector using the key feature vector 506, as discussed further herein with reference to FIGS. 6, 10, 11, and 12C-12G. In an embodiment, the feature generator 504 may leave the key feature vector 506 unaltered and use it as the feature vector. In an embodiment, the feature generator 504 may us portions of a first key feature vector 506 combined with portions of a second the key feature vector 506 to generate the feature vector. The generated feature vectors may represent vectorized portions of the raw data. The feature vectors may be output to the vector units 304 associated with the feature buffer 306.

FIG. 6 illustrates an example feature generator 504 suitable for implementing an embodiment. The feature generator 504 may be connected between the feature queue 502 and the vector units 304 associated with the feature buffer having the feature generator 504. The feature generator 504 may receive key feature vectors from the feature queue 502 and output feature vectors to the vector units 304. The feature generator 504 may include a storage device for the received key feature vector, such as a current feature register 600, and an operation device for modifying the received key feature vectors, such as the feature shifter 602. The feature generator 504 may be configured to generate feature vectors based on various factors, including the machine learning algorithms implemented, the size and/or complexity of the raw data, the power and/or performance requirements of the computing device, the processing requirements for the raw data, the number and capability of the vector units of the machine learning accelerator, and the configuration of the key feature vectors, and the configuration of the key feature vectors.

A key feature vector received from the key feature queue 502 may be written to the current feature register 600. In an embodiment, the feature generator 504 may alternate between using the key feature vector as is to generate the feature vector and modifying the key feature vector to generate the feature vector. For feature vectors generated from unmodified key feature vectors, the feature generator 504 may output the generated feature vector to the connected vector units 304. For feature vectors generated from modified key feature vectors, the feature generator 504 may write the received key feature vector from the current feature register 600 to the feature shifter 602. The key feature vector written to the feature shifter 602 may be modified by combining the key feature vector with another key feature vector to generate a feature vector that is a combination of multiple key feature vectors. The generated feature vector may be written to the current feature register 600 and output to the connected vector units 304.

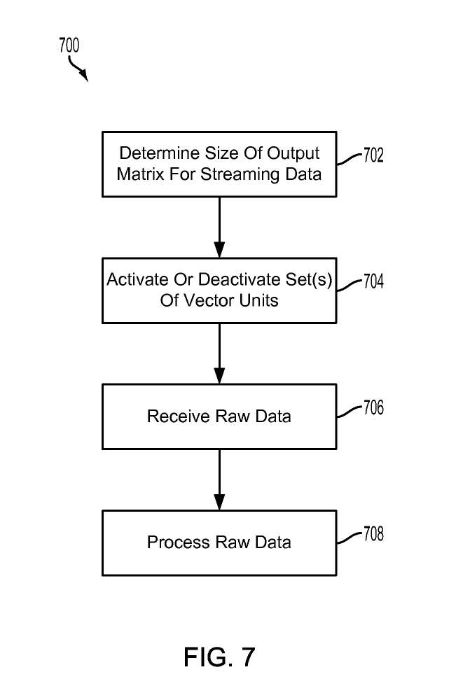

FIG. 7 illustrates an embodiment method 700 for implementing acceleration of machine learning and raw data analysis. The method 700 may be implemented in a computing device in software executing in a processor, in general purpose hardware, or dedicated hardware, such as a processor executing software within a machine learning accelerator that includes other individual components. In order to encompass the alternative configurations enabled in the various embodiments, the hardware implementing the method 700 is referred to herein as an “apparatus.”

In block 702, an apparatus (e.g., a machine learning accelerator) of a computing device may determine a size of a processing matrix for the streaming data. The size of the processing matrix for the streaming data may be used to activate and deactivate the feature buffers and vector units of the machine learning accelerator. The processing matrix may be implemented in a variety of configurations depending on various factors, including the machine learning algorithms implemented, the size and/or complexity of the raw data, the power and/or performance requirements of the computing device, and the processing requirements for the raw data. The processing matrix is not required to be the same size as the output matrix. For example, the processing matrix may be smaller than the output matrix, because the activated vector units may output their partial outputs of the output matrix, and the output matrix may be assembled in the output buffer using multiple partial outputs from the vector units.

In block 704, the apparatus may activate or deactivate one or more sets (e.g., rows or columns) of vector units. In an embodiment, a feature buffer associated with deactivated vector units may also be deactivated when all of its associated vector units are deactivated. In an embodiment, a feature buffer associated with activated vector units may also be activated when even a single associated vector unit is activated. In block 706, the apparatus may receive the raw data, either on a streaming or as need basis. In an embodiment, the raw data may be received at the machine learning accelerator from the raw data source device. In block 708, the apparatus may process the raw data, discussed further herein with reference to FIGS. 5, 6, and 8-19.

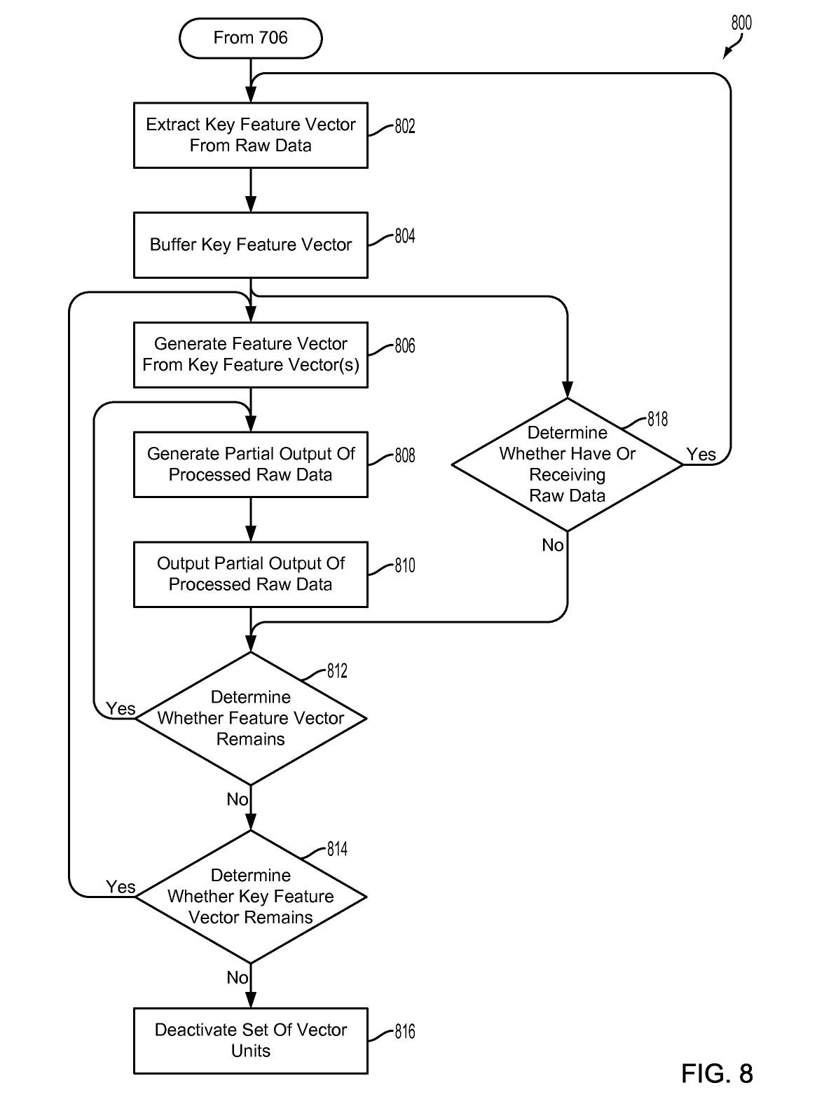

FIG. 8 illustrates an embodiment method 800 for accelerating machine learning and raw data analysis. The method 800 may be executed as part of block 708 in the method 700. The method 800 may be implemented in a computing device in software executing in a processor, in general purpose hardware, or dedicated hardware, such as a processor executing software within a machine learning accelerator that includes other individual components. In order to encompass the alternative configurations enabled in the various embodiments, the hardware implementing the method 800 is referred to herein as an apparatus.

In block 802, an apparatus of the computing device may extract key features from the raw data received in a streaming or as needed manner. Which of the raw data may be used in the key feature vectors and how the raw data is used to generate the key feature vectors may be determined based on the size and stride parameters for generating the key feature vectors, as discussed further herein with reference to FIGS. 5, 9, 12A, and 12B.

In block 804, the apparatus may buffer the key feature vectors. In an embodiment, buffering the key feature vectors may include writing the key feature vectors to appropriate locations in the key feature buffers.

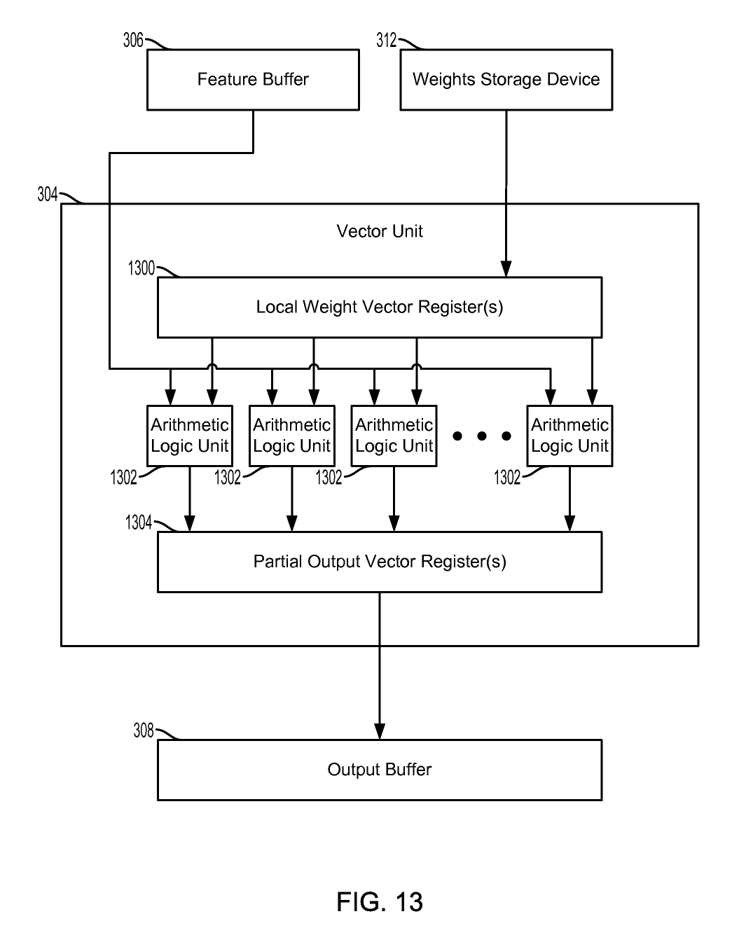

In block 806, the apparatus may generate feature vectors from the key feature vectors, as discussed further herein with reference to FIGS. 6, 10, 11, and 12C-12G. In block 808, the apparatus may generate a partial output of the processed raw data. In an embodiment the feature vectors may be used in an operation to generate and output the partial output of the processed raw data as discussed further herein with reference to FIGS. 13-19. In block 810, the apparatus may output the partial output of the processed raw data. In an embodiment, the partial output may be output from the vector units to the output buffer.

Concurrently with various blocks of the method 800 (e.g., stemming from block 804 and concurrent with one or more of blocks 806-810), in determination block 818, the apparatus may determine whether it has or is receiving more raw data. In an embodiment, the raw data may be retained or received at the apparatus (e.g., a machine learning accelerator) from the raw data source device. The apparatus may have or be receiving more raw data when the apparatus is retaining already received raw data, such as in a feature buffer before the key feature vectors are extracted, or when the apparatus is receiving additional raw data from the raw data source device in a streaming or as needed manner. In response to determining that the apparatus has or is receiving raw data (i.e., determination block 818=“Yes”), the apparatus may extract key feature vectors from the raw data in block 804.

In response to determining that the apparatus does not have or is not receiving raw data (i.e., determination block 818=“No”), or stemming from another block of the method 800 (e.g., block 810), the apparatus may determine whether it has any feature vectors remaining in determination block 812. In an embodiment, the feature vectors may be retained by the machine learning accelerator, for example in the vector units as the vector units operate using the feature vectors.

In response to determining that the apparatus has remaining feature vectors (i.e., determination block 812=“Yes”), the apparatus may generate a partial output of the processed raw data in block 808.

In response to determining that the apparatus does not have remaining feature vectors (i.e., determination block 812=“No”), the apparatus may determine whether it has any key feature vectors remaining in determination block 814. In an embodiment, the key feature vectors may be retained by the machine learning accelerator, for example in the key feature queue of the feature buffer.

In response to determining that the apparatus has remaining key feature vectors (i.e., determination block 814=“Yes”), the apparatus may generate feature vectors from the key feature vectors in block 806.

In response to determining that the apparatus does not have remaining key feature vectors (i.e., determination block 814=“No”), the apparatus may deactivate a set of vector units associated with a feature buffer lacking key feature vectors. In an embodiment, the feature buffer associated with the vector units to be deactivated and also lacking key feature vectors may also be deactivated.

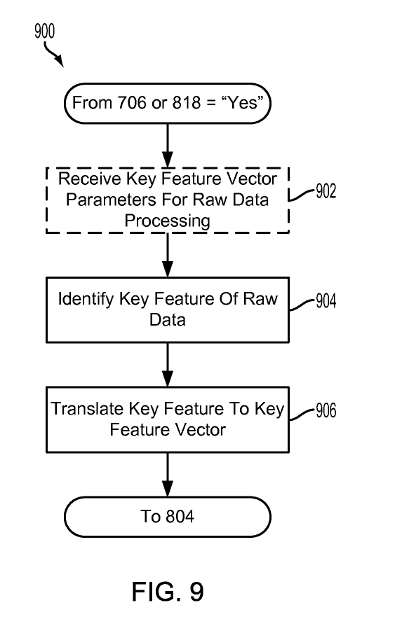

FIG. 9 illustrates an embodiment method 900 for extracting a key feature vector from raw data. The method 900 may be executed as part of block 708 in the method 700 or as part of block 802 in the method 800. The method 900 may be implemented in a computing device in software executing in a processor, in general purpose hardware, or dedicated hardware, such as a processor executing software within a machine learning accelerator that includes other individual components. In order to encompass the alternative configurations enabled in the various embodiments, the hardware implementing the method 900 is referred to herein as an apparatus.

In optional block 902, the apparatus of the computing device may receive key feature vector parameters for raw data processing. In an embodiment, the key feature vector parameters may include a size parameter and a stride parameter. In an embodiment, the key feature vector parameters may be predetermined or determined based on a type of machine learning, a granularity for processing the raw data, and/or a number and capability of the vector units of the machine learning accelerator.

In block 904, the apparatus may identify key features of the raw data. The apparatus may apply the key feature vector parameters to a block of received raw data to identify a key feature of the raw data. In an embodiment, the key features of the raw data may be defined by a two dimensional matrix of raw data values from the raw data, for example a two dimensional matrix starting at a beginning of the block of raw data. Each successive key feature of the raw data may be identified using the same size parameter, or the same two dimensional matrix, applied to a different location in the raw data. The location of each successive key feature may be determined based on the location of the previous key feature and the stride parameter. The stride parameter may indicate where to locate a successive key feature based on the location of the previous key feature by indicating a number of units from the previous location to apply the size parameter to determine the successive key feature. In an embodiment, the size and stride parameters may be defined such that successive key features of the raw data avoid including raw data from a previous key feature of the raw data. In an embodiment, the stride parameter may equal one of the dimensions of the size parameter.

In block 906, the apparatus may translate the key features to key feature vectors. The apparatus may be configured to translate the key features to key feature vectors in a variety of way. In an embodiment, translating the key features to key feature vectors may include appending successive rows of the two dimensional matrix of raw data to a first or previous row of the two dimensional matrix, such that the translated key feature vector represents an array-like structure of the raw data of the two dimensional matrix. However, any translation of the key features to key feature vectors may be used, so long as the key feature vectors are usable to generate feature vectors that can be properly processed to produce the output matrix. The method 900 may return to the method 800 and buffer the key feature vectors in block 804.

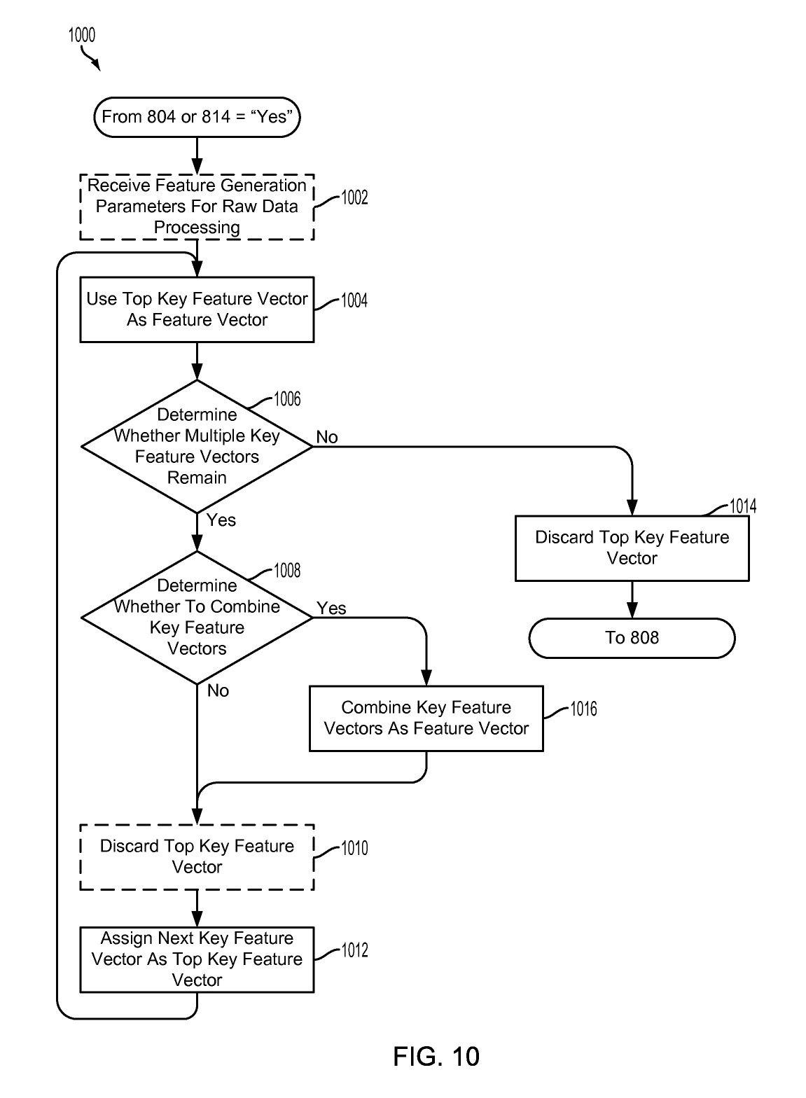

FIG. 10 illustrates an embodiment method 1000 for generating a feature from a key feature vector(s). The method 1000 may be executed as part of block as part of block 806 in the method 800. The method 1000 may be implemented in a computing device in software executing in a processor, in general purpose hardware, or dedicated hardware, such as a processor executing software within a machine learning accelerator that includes other individual components. In order to encompass the alternative configurations enabled in the various embodiments, the hardware implementing the method 1000 is referred to herein as an apparatus.

In optional block 1002, the apparatus of the computing device may receive feature generation parameters for raw data processing, such as the size of the feature vector. In an embodiment the parameters for raw data processing may depend on various factors, including the machine learning algorithms implemented, the size and/or complexity of the raw data, the power and/or performance requirements of the computing device, the processing requirements for the raw data, the number and capability of the vector units of the machine learning accelerator, and the configuration of the key feature vectors. In an embodiment, the size of the feature vector may equal the size of the key feature vector.

In block 1004, the apparatus may use the top key feature vector, for example from the top of the key feature queue, as a feature vector. In an embodiment, the generation of a feature vector may not require any manipulation of the key feature vector, and may use the key feature vector data as is to generate the feature vector.

In determination block 1006, the apparatus may determine whether multiple key feature vectors remain. In an embodiment, the key feature vectors may be retained by the apparatus in the key feature queue of the machine learning accelerator. Different locations in the key feature queue may be loaded with a key feature vector. As the key feature vectors are used, the locations in the key feature queue may be emptied of nullified. Thus, under various circumstances the key feature queue may contain no key feature vectors, a single key feature vectors, or multiple key feature vectors.

In response to determining that multiple key feature vectors do not remain (i.e., determination block 1006=“No”), the apparatus may discard or nullify the top key feature vector in block 1014. The method 1000 may return to the method 800 and generate a partial output of the processed raw data in block 808.

In response to determining that multiple key feature vectors do remain (i.e., determination block 1006=“Yes”), the apparatus may determine whether to combine the key feature vectors in determination block 1008. The determination whether to combine key vectors may depend on whether a key feature vector has or a combination of key feature vectors have already been used to generate a feature vector.

In an embodiment, feature vectors may be generated by using a single key feature vector, as in block 1004, or by combining multiple key feature vectors. Combining key feature vectors may allow the apparatus to generate feature vectors that are not created from the key feature vectors when they are used alone to generate the feature vector. In an embodiment, the extraction of key features and translation to key feature vectors may leave out combinations of raw data that may be needed to properly process the raw data to produce the output matrix. The combination of key feature vectors may allow the computing device to recreate those combinations of raw data without having to execute costly reads of the raw data to create each combination as a separate key feature vector. Therefore, depending on the extraction and translation of the key feature vectors, different combinations of key feature vectors may produce desired feature vectors.

In an embodiment, the apparatus may determine not to combine key feature vectors when the top key feature vector has not been used in generating a feature key, and to combine key feature vectors when the top key feature vector has been used in generating a feature key. In an embodiment, the apparatus may determine not to combine key feature vectors when the key feature vectors have been previously combined.

In response to determining not to combine the key feature vectors (i.e., determination block 1008=“No”), the apparatus may discard or nullify the top key feature vector in optional block 1010. In block 1012, the apparatus may assign the next key feature vector in the key feature queue as the top key feature vector. In an embodiment, rather than discarding or nullifying the top key feature vector, in a circular key feature queue mode, the apparatus may also assign the previous top key feature vector to another position in the key feature queue. In block 1004, the apparatus may use the top key feature as a feature vector.

In response to determining to combine the key feature vectors (i.e., determination block 1008=“Yes”), the apparatus may combine the key feature vectors to generate a feature vector in block 1016. In an embodiment, apparatus may combine any of the key feature vectors, such as the top key feature vector and a next key feature vector. The combination of the key feature vectors may occur in various manners. For example, the combination of the key feature vectors may include the combination of successive key feature vectors such that the combination creates a data set of a key feature not identified by the apparatus such that the key feature would have included data from both of the successive key features. As discussed herein, combining the key features to create data sets of unidentified key features allows the computing device to avoid costly reads of the raw data to identify such key features.

In optional block 1010, the apparatus may discard the top key feature vector. In block 1012, the apparatus may assign the next key feature vector in the key feature queue as the top key feature vector. In block 1004, the apparatus may use the top key feature as a feature vector.

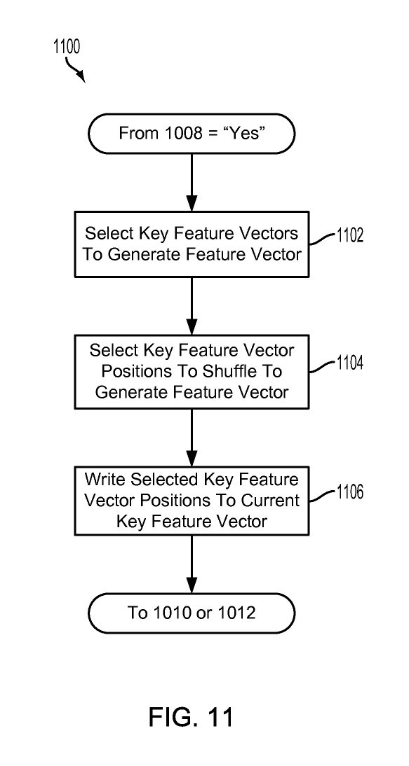

FIG. 11 illustrates an embodiment method 1100 for combining a top key feature vector and a next key feature vector as a feature. The method 1100 may be executed as part of block as part of block 1016 in the method 1000. The method 1100 may be implemented in a computing device in software executing in a processor, in general purpose hardware, or dedicated hardware, such as a processor executing software within a machine learning accelerator that includes other individual components. In order to encompass the alternative configurations enabled in the various embodiments, the hardware implementing the method 1100 is referred to herein as an apparatus.

In block 1102, the apparatus of the computing device may select at least two key feature vectors to generate a feature vector. In an embodiment, the key feature vectors may include at least the current key feature vector, which may be the top key feature vector, and a successive key feature vector in the key feature queue.

In block 1104, the apparatus may select key feature vector positions to shuffle to generate the feature vector. The key feature vector positions may be selected from each of the selected key feature vectors such that each position selected among the various selected key feature vectors represents a different location in the raw data that is not represented by another selected key feature position. The selected key feature positions may also represent an unidentified key feature of the raw data, for example a data set of the raw data with the same two dimensional characteristics as an identified key feature and spanning multiple identified key features.

In block 1106, the apparatus may write the selected key feature positions to the current key feature vector. In an embodiment, writing the selected key feature positions to the current key feature vector may be accomplished by writing the selected key feature positions in an order that would result from the translation of the unidentified key feature, represented by the selected key feature positions, to a key feature vector.

The method 1100 may return to the method 1000 and the apparatus may discard the top key feature vector in optional block 1010, or the apparatus may assign the next key feature vector in the key feature queue as the top key feature vector in block 1012.

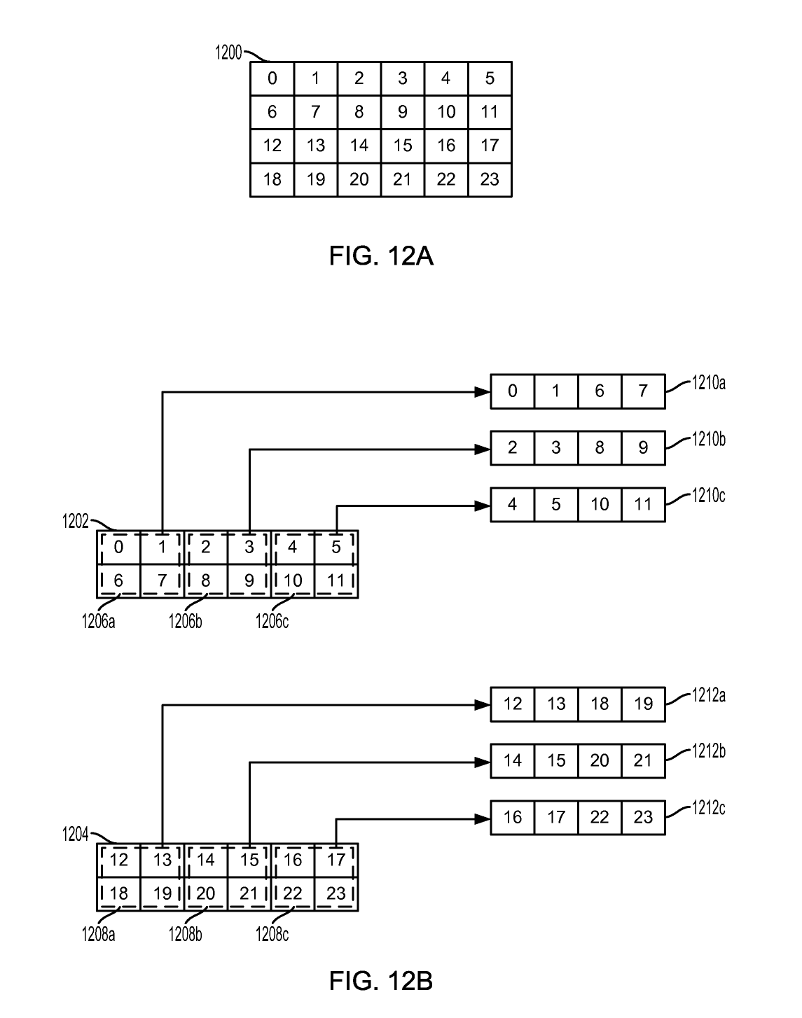

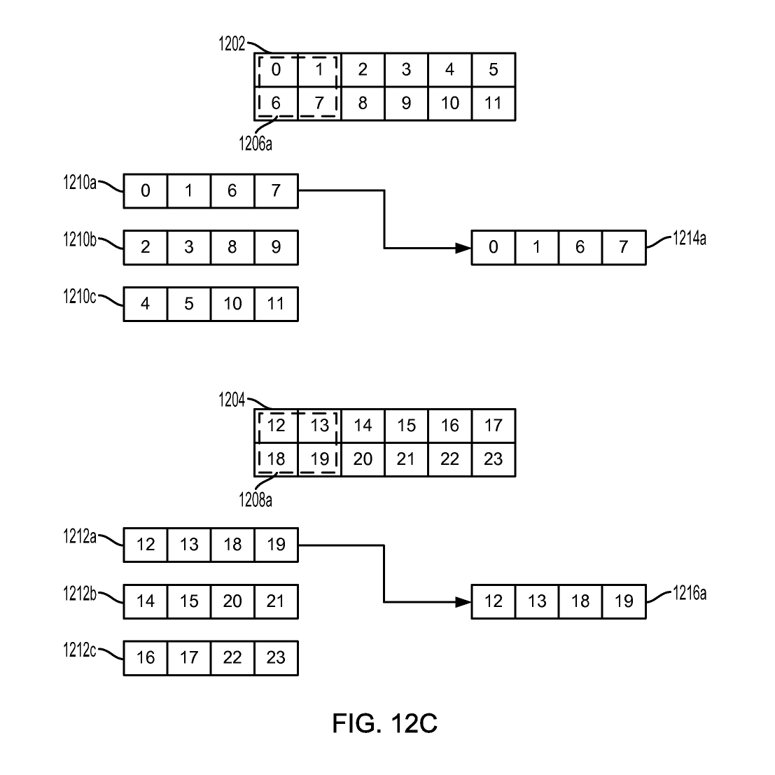

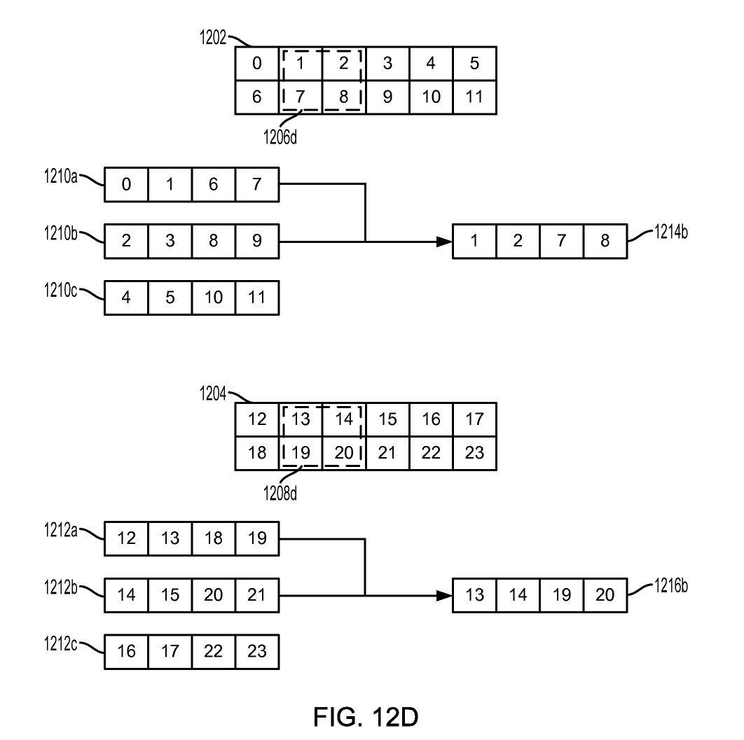

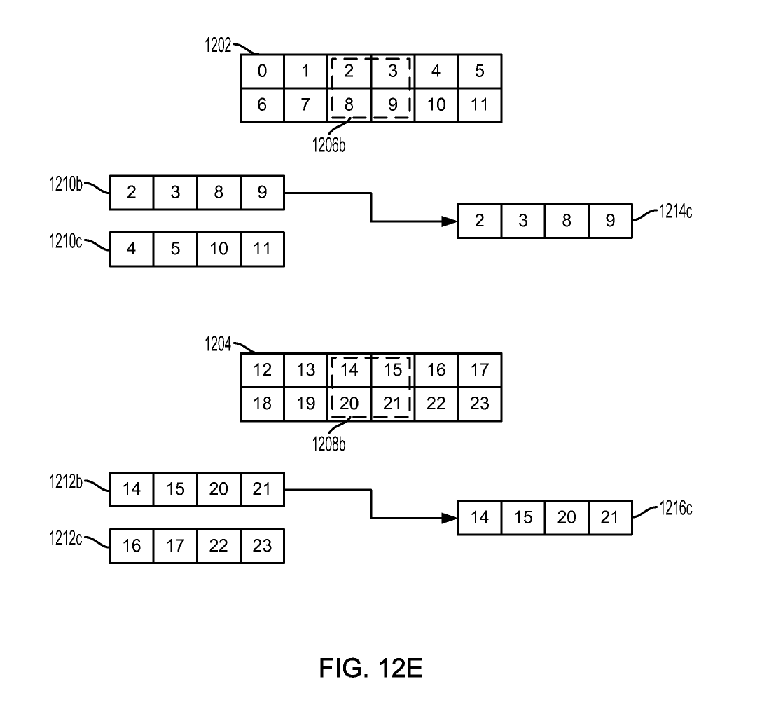

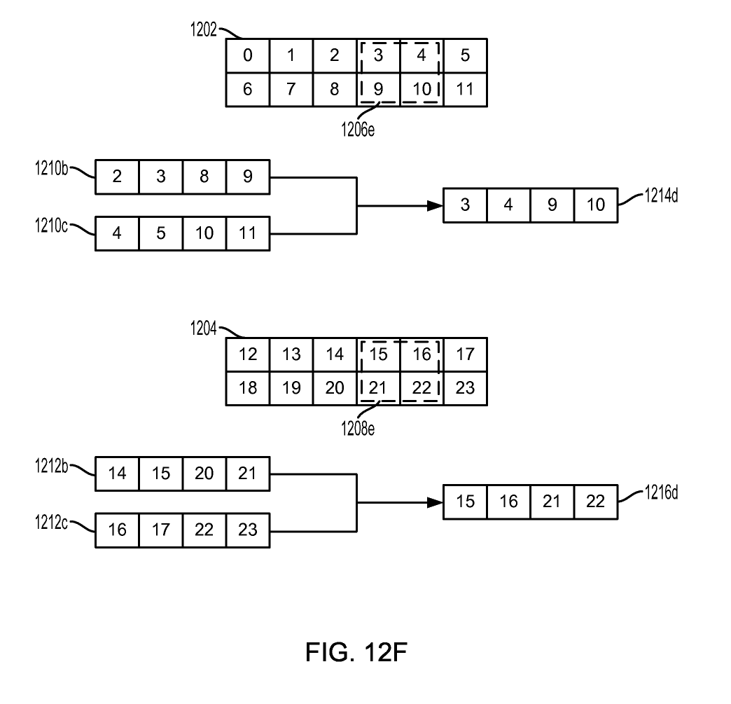

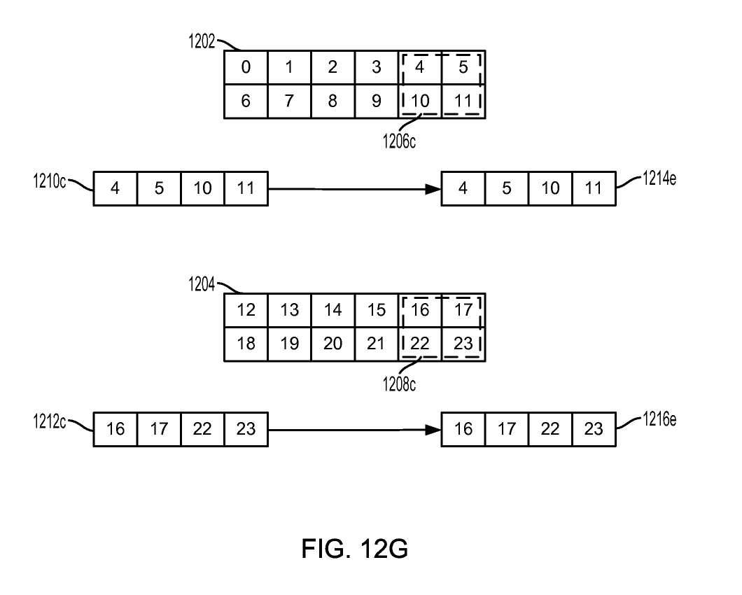

FIGS. 12A-12G illustrate an example of a process flow for extracting a key feature vector from raw data and generating a feature vector from the key feature vector for implementing an embodiment. This is only an example and not limiting in any manner, particularly with respect to the size, number, configuration, or content of the raw data, key features, key feature vectors, and feature vectors.

FIG. 12A illustrates an example raw data set 1200 from which key features may be identified, and key feature vectors and feature vectors may be generated as described further herein with reference to FIGS. 12B-12G. Each location in the raw data set 1200 may represent a separate unit of data. In different raw data sets 1200, the units of data may vary, for example the units may be a bit or a byte of data.

FIG. 12B illustrates the apparatus identifying the key features 1206, 1208 of various portions of the raw data set 1202, 1204 received by different feature buffers. For this example, the key feature vector parameters may be defined as a two-by-two matrix and a two unit stride. Based on these key feature vector parameters, key features 1206 (e.g., 1206a-1206c), 1208 (e.g., 1208s-1208c) may be identified to represent the entire raw data set 1200. Each key feature may be translated into a key feature vector 1210, 1212 (e.g., key feature 1206a may be translated into key feature vector 1210a; key feature 1206b may be translated into key feature vector 1210b; key feature 1206c may be translated into key feature vector 1210c; key feature 1208a may be translated into key feature vector 1212a; key feature 1208b may be translated into key feature vector 1212b; and key feature 1208c may be translated into key feature vector 1212c). The key feature vectors 1210, 1212 may be held in their respective key feature queues.

As illustrated in FIG. 12C, an apparatus of the apparatus may generate a feature vector 1214a, 1216a from the top key feature vector 1210a, 1212a from each key feature queue. In an embodiment, this particular generation of feature vectors 1214a, 1216a may include generating the feature vectors 1214a, 1216a without manipulation of the key feature vectors 1210a, 1212a. The generated feature vectors 1214a, 1216a may contain data corresponding to raw data of respective key features 1206a, 1208a.

FIG. 12D illustrates that the apparatus of the computing device may combine the top key feature vectors 1210a, 1212a with a next key feature vector 1210b, 1212b to generate another feature vector 1214b, 1216b. The data selected from the top key feature vectors 1210a, 1212a and the next key feature vectors 1210b, 1212b may correspond with previously unidentified key features 1206d, 1208d. In this example, the previously unidentified key features 1206d, 1208d may be such that they span previously identified key features 1206a, 1206b and 1208a, 1208b, respectively.

FIG. 12E illustrates when that the top key feature vectors 1210a, 1212a are no longer in the key feature queue, and previously next key feature vectors 1210b, 1212b have been reassigned as top key feature vectors 1210b, 1212b. Much like in FIG. 12C, the apparatus may generate a feature vector 1214c, 1216c from the top key feature vector 1210b, 1212b from each key feature queue, without manipulating the top key feature vector 1210b, 1212b such that they contain data corresponding to raw data of respective key features 1206b, 1208b.

Much like in FIG. 12D, in the example illustrated in FIG. 12F, the apparatus of the computing device may combine the top key feature vectors 1210b, 1212b with a next key feature vector 1210c, 1212c to generate another feature vector 1214d, 1216d, such that the data of each feature vector 1214d, 1216d may correspond with previously unidentified key features 1206e, 1208e.

Much like in FIG. 12E, in the example illustrated in FIG. 12G, the top key feature vectors 1210b, 1212b are no longer in the key feature queue, and previously next key feature vectors 1210c, 1212c have been reassigned as top key feature vectors 1210c, 1212c. The apparatus of the apparatus may generate a feature vector 1214e, 1216e from the top key feature vector 1210c, 1212c from each key feature queue, without manipulating the top key feature vector 1210c, 1212c such that they contain data corresponding to raw data of respective key features 1206c, 1208c.

FIG. 13 illustrates an example vector unit 304 suitable for implementing an embodiment. The vector unit 304 may be connected between an associated feature buffer 306, the weight storage device 312, and the output buffer 308. The vector unit 304 may receive feature vectors from the associated feature buffer 306 as they are generated and output to the vector unit 304. As described herein, the vector unit may be one of a number of vector units 304 associated with the feature buffer 306 and receiving the feature vector.

Portions of the received feature vectors may be provided to at least one process unit 1302, which may include an arithmetic logic unit (ALU) or other programmable logic device, for executing operations, such as basic linear algebra subprogram operation, using the portions of the feature vectors. The vector unit 304 may also receive a weight factor from the weight storage device 312.

The vector unit 304 may include at least one local weight vector register 1300 configured to temporarily store the received weight factor, and output the weight factor to the process unit 1302 for use in executing its operations using the received feature vector. In an embodiment, the weight factor may include a single value or a number of values, and may be configured a vector, such as a vector with a number of positions that may correspond to a number of process units 1302 in the vector unit 304. Each local weight vector register 1300 may be associated with a particular process unit 1302, and may output all or part of the weight factor to the associated process unit 1302.

The process units 1302 may execute an operation using the received feature vector and the received weight factor to generate a pre-partial output of the output matrix. The process units 1302 may output the pre-partial output to at least one partial output vector register 1304, which may be configured to temporarily store the received the pre-partial output, and combine multiple pre-partial outputs from the various process units 1302 into a partial output vector. The partial output vector registers 1304 may store the pre-partial outputs until receiving a pre-partial output from all of the process units 1302. The partial output vector registers 1304 may output the pre-partial outputs as a partial output vector to the output buffer 308.

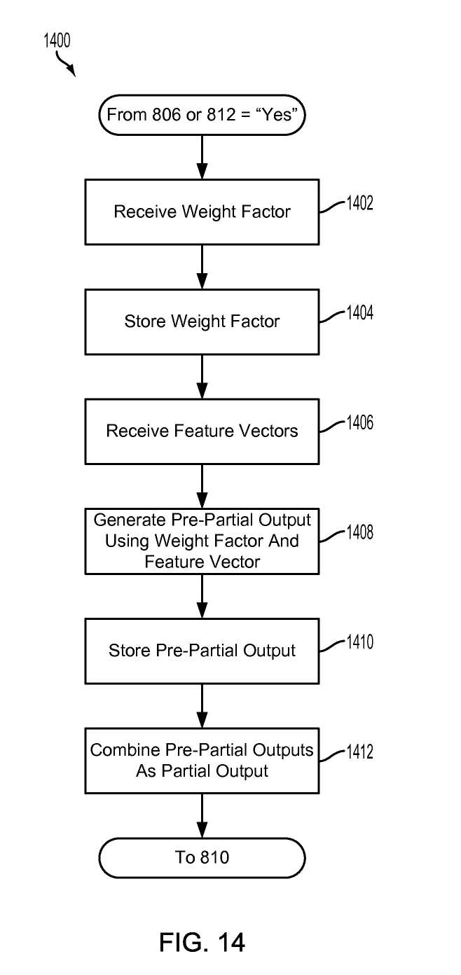

FIG. 14 illustrates an embodiment method 1400 for generating a partial output of a processed raw data. The method 1400 may be executed as part of block as part of block 808 in the method 800. The method 1400 may be implemented in a computing device in software executing in a processor, in general purpose hardware, or dedicated hardware, such as a processor executing software within a machine learning accelerator that includes other individual components. In order to encompass the alternative configurations enabled in the various embodiments, the hardware implementing the method 1400 is referred to herein as an apparatus.

In block 1402, the apparatus of the computing device may receive the weight factor. As discussed herein, the weight factor may be a single weight value or a vector of weight values, and may be the same or different for each or a set of vector units. The weight factor received may depend on the type of machine learning accelerated by the machine learning accelerator.

In block 1404, the apparatus may store the received weight factor. The weight factor may be stored temporarily by the apparatus, for example in a weight buffer or weight vector register, at least until the apparatus is prepared to use the weight factor in generating the output matrix. In an embodiment, the weight factor may change for operations with different feature vectors of the same or different raw data, and a new weight factor may be received and stored to be used in the operations. In an embodiment, the weight factors may be persistent for operations with different feature vectors of the same or different raw data, and the same weight factor may be retained and repeatedly used in various operations.

In block 1406, the apparatus may receive feature vectors. For example, the vector units may receive feature vectors from their associated feature buffers. Various vector units may receive different feature vectors depending on the feature buffer with which they are associated and the raw data received by the associated feature buffer. The apparatus may receive the feature vectors in a streaming or as needed manner.

In block 1408, the apparatus may generate a pre-partial output using the weight factor and the feature vector. In an embodiment, the vector units may execute a variety of operations, including basic linear algebra subprogram operations, using the received weight factors and the feature vectors. The vector units may use any combination of the entire or part of the weight factor and the entire or part of the feature vector it receives in the operation to generate the pre-partial output.

In block 1410, the apparatus may store the pre-partial output. The pre-partial output may be only part of the partial output of the output matrix. In an embodiment, the partial output may include multiple pre-partial outputs generated from multiple vector units, such as vector units associated with the same feature buffer. In an embodiment, the partial output may include multiple pre-partial outputs generated from multiple process elements, such as process element belonging to the same vector unit. The apparatus may store each pre-partial output until there are sufficient pre-partial outputs stored to compose a partial output of the output matrix.

In block 1412, the apparatus may combine the pre-partial outputs to compose the partial output. The method 1400 may return to the method 800 and output the partial output of the processed raw data in block 810.

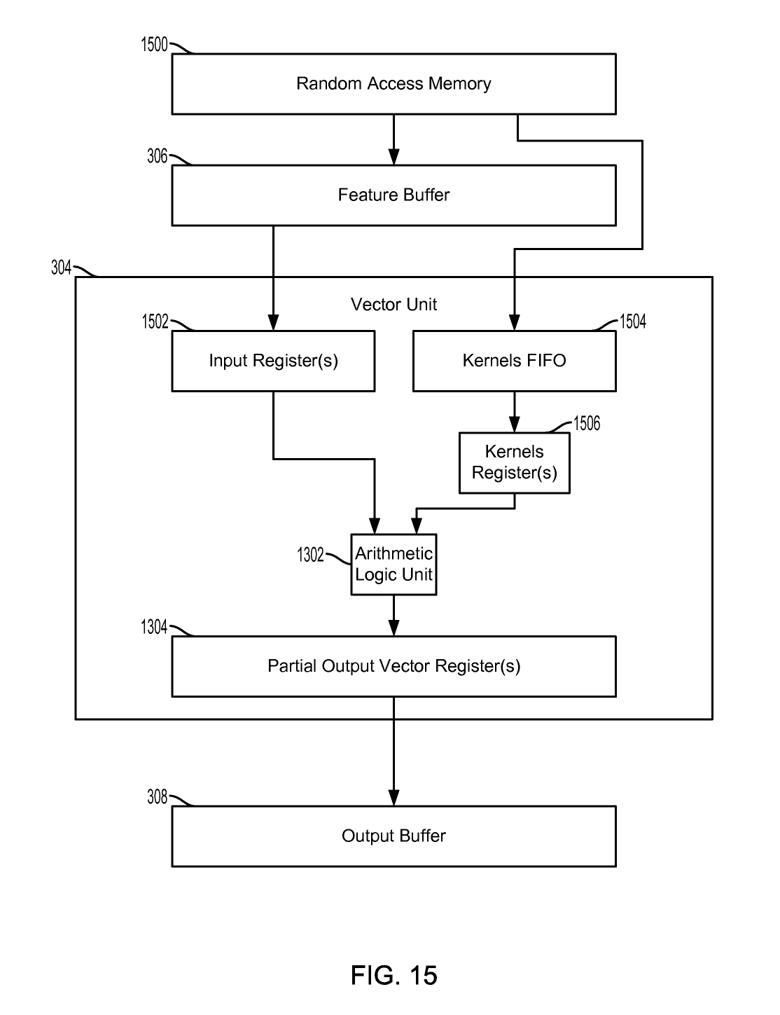

FIG. 15 illustrates an example vector unit 304 suitable for implementing an embodiment. The vector unit 304 may be connected between an associated feature buffer 306, the weight storage device 312, and the output buffer 308. In an embodiment, the feature buffer 306 may also be connected to a raw data source device, such as a random access memory 1500. The vector unit 304 may receive feature vectors from the associated feature buffer 306 as they are generated and output to the vector unit 304. As described herein, the vector unit may be one of a number of vector units 304 associated with the feature buffer 306 and receiving the feature vector. The received feature vectors may be temporarily stored in at least one input register 1502.

A kernels (or weights) first-in first-out (FIFO) register 1504 may receive raw data from the raw data source device. The kernels (or weight factor) first-in first-out register 1504 may provide at least one kernels (or weights) register 1506 with data from the received raw data in a first-in first-out manner. The kernels (or weights) register 1506 may act as a filter for the data from the raw data, limiting the data available for use based on the size of the kernels (or weights) register 1506, thereby generating kernels (or weights) for us in generating a pre-partial output. In an embodiment the kernels (or weights) may include portions of the raw data.

The received feature vectors and the kernels (or weights) may be provided to a process unit 1302, which may include an arithmetic logic unit (ALU), a multiply-accumulate (MAC) unit, or other programmable logic device, for executing operations, such as basic linear algebra subprogram operation, using the feature vectors and the kernels (or weights). The process unit 1302 may execute its operation and output a pre-partial output to at least one partial output vector register 1304, which may be configured to temporarily store the received the pre-partial output, and combine multiple pre-partial outputs from the various process units 1302 into a partial output vector.

The partial output vector registers 1304 may store the pre-partial outputs until receiving a pre-partial output from all of the process units 1302. The partial output vector registers 1304 may output the pre-partial outputs as a partial output vector to the output buffer 308.

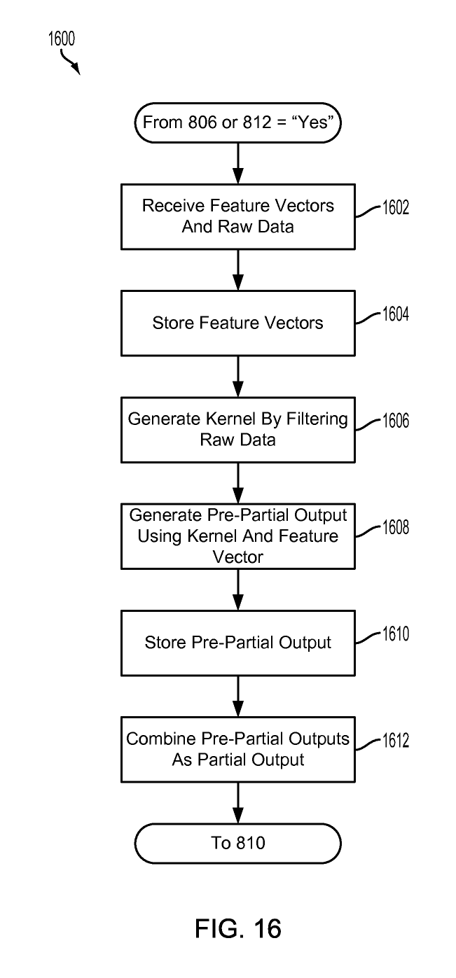

FIG. 16 illustrates an embodiment method 1600 for generating a partial output of a processed raw data. The method 1600 may be executed as part of block as part of block 808 in the method 800. The method 1600 may be implemented in a computing device in software executing in a processor, in general purpose hardware, or dedicated hardware, such as a processor executing software within a machine learning accelerator that includes other individual components. In order to encompass the alternative configurations enabled in the various embodiments, the hardware implementing the method 1600 is referred to herein as an apparatus.

In block 1602, the apparatus of the computing device may receive feature vectors and raw data. In an embodiment, the feature vectors may be received in the input registers of the vector units from the feature buffers with which the vector units are associated, and the raw data may be received in the kernels (or weight factor) first-in first-out register from the raw data source device. Different kernels (or weight factor) first-in first-out register for different vector units may receive the same or different portions of the raw data. The feature vectors and raw data may be received in a streaming or as needed manner.

In block 1604, the apparatus may store the received feature buffers. Temporary storage of the received feature buffers may be implemented to allow for completion of previous operation execution and filtering of the raw data.

In block 1606, the apparatus may filter the raw data. In an embodiment, filtering the raw data may include selecting a portion of the received raw data, or filter location, to apply to the operation with the feature vector. In embodiments where different kernels (or weight factor) first-in first-out register for different vector units may receive the same portions of the raw data, using different filter locations may result in different filter values. In embodiments where different kernels (or weight factor) first-in first-out register for different vector units may receive different portions of the raw data, using the same filter locations may result in different filter values.

In block 1608, the apparatus may generate a pre-partial output using the kernel (or weight factor) and the feature vector. In an embodiment, the vector units may execute a variety of operations, including basic linear algebra subprogram operations, using the filtered kernel (or weight factor) and the received feature vectors. The vector units may use any combination of the kernel (or weight factor) and the entire or part of the feature vector it receives in the operation to generate the pre-partial output.

In block 1610, the apparatus may store the pre-partial output. The pre-partial output may be only part of the partial output of the output matrix. In an embodiment, the partial output may include multiple pre-partial outputs generated from multiple vector units, such as vector units associated with the same feature buffer. In an embodiment, the partial output may include multiple pre-partial outputs generated from multiple process elements, such as process element belonging to the same vector unit. The apparatus may store each pre-partial output until there are sufficient pre-partial outputs stored to compose a partial output of the output matrix.

In block 1612, the apparatus may combine the pre-partial outputs to compose the partial output. The method 1600 may return to the method 800 and output the partial output of the processed raw data in block 810.

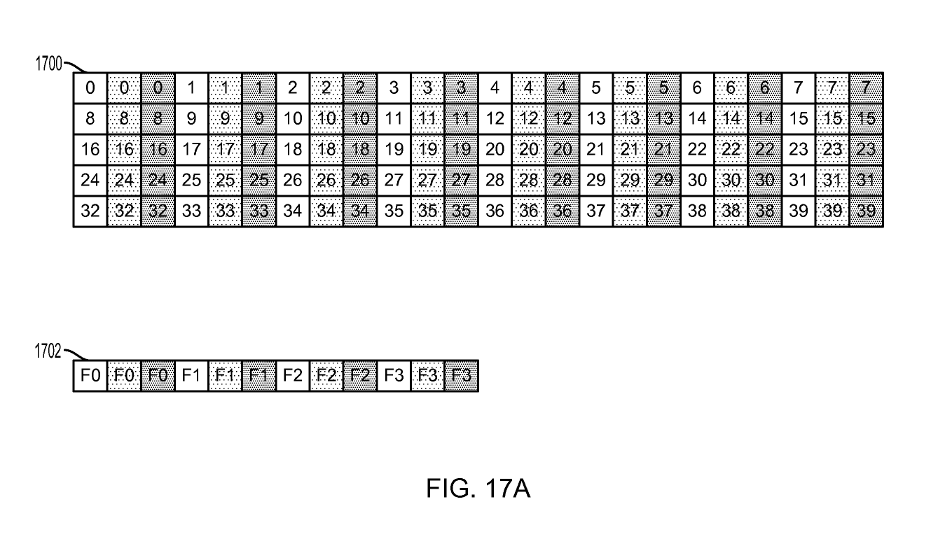

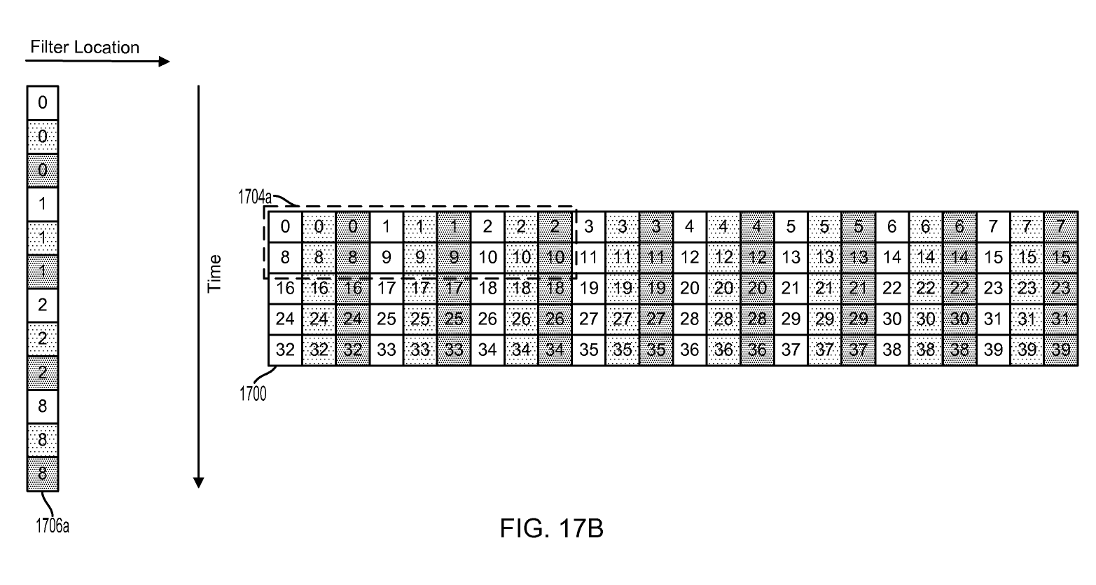

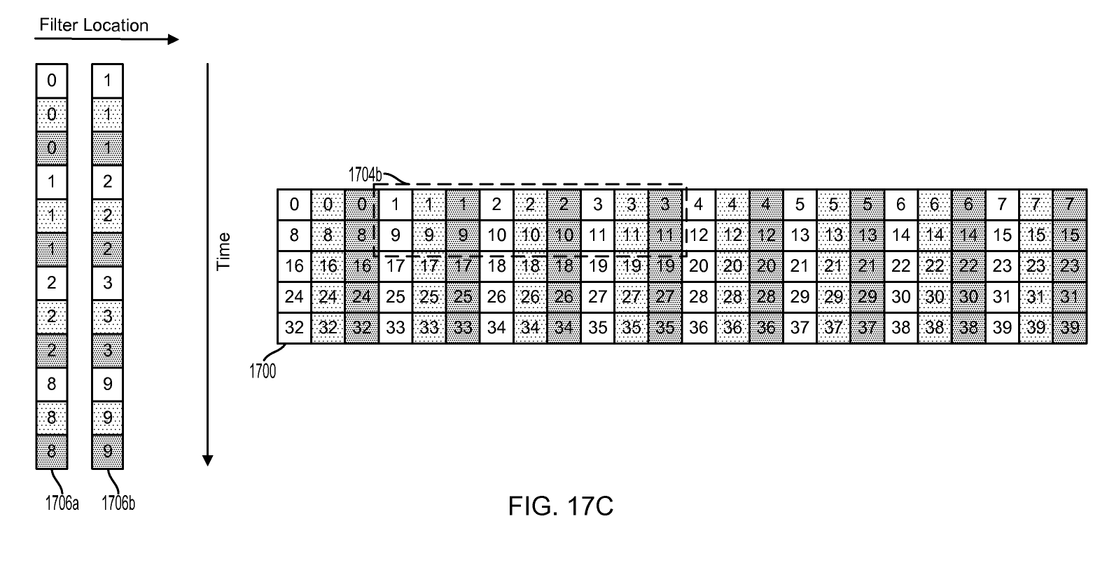

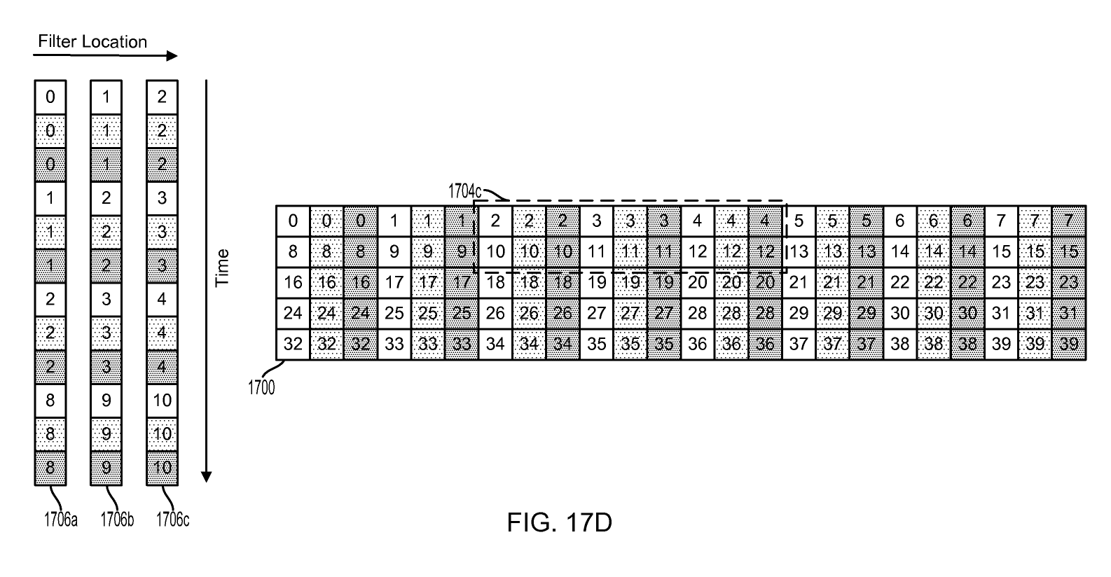

FIGS. 17A-17D illustrate an example of a process flow for generating a kernel using filtered raw data. This is only an example and not limiting in any manner, particularly with respect to the size, number, configuration, or content of the raw data, feature vectors, and kernel (or weight factors).

FIG. 17A illustrates an example raw data set 1700 from which feature vectors may be generated and kernel (or weight factors) may be filtered, as described further herein with reference to FIGS. 17B-17D. Each location in the raw data set 1700 may represent a separate unit of data. In different raw data sets 1700, the units of data may vary, for example the units may be a bit or a byte of data. In this example, like shading may represent a different data channel from other shading. For example, the data channels may represent different pixel colors for raw image or video data. FIG. 17A illustrates an example filter queue 1702 having a set of filter locations for filtering data from the raw data set 1700.

FIG. 17B illustrates an application of a first filter location 1704a to the raw data set 1700 that may generate a first filtered portion 1706a for a particular vector unit. Similarly, in the continued examples shown in FIGS. 17C and 17D, the application of other filter locations 1704b, 1704c to the raw data set 1700 may generate other filtered portions 1706b, 1706c for other vector units. The number of filter locations and the amount of data they extract from the raw data set in these examples is not limiting and the number of filter locations and the amount of data they extract may vary based up various factors, including the machine learning algorithms implemented, the size and/or complexity of the raw data, the power and/or performance requirements of the computing device, and the processing requirements for the raw data.

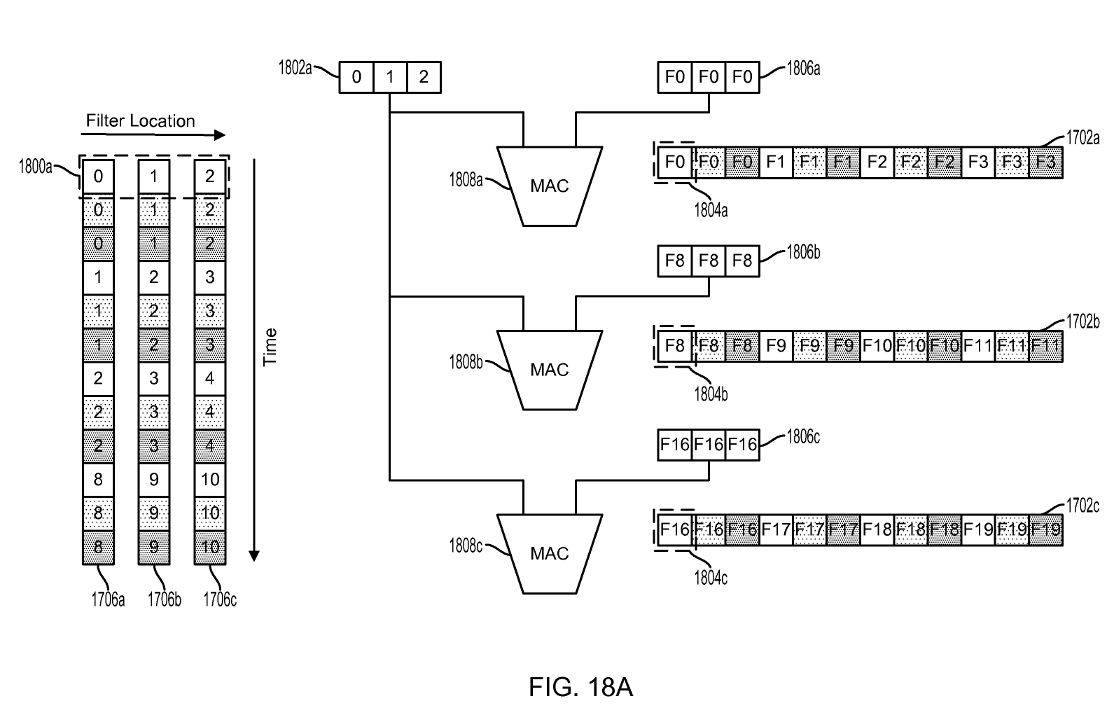

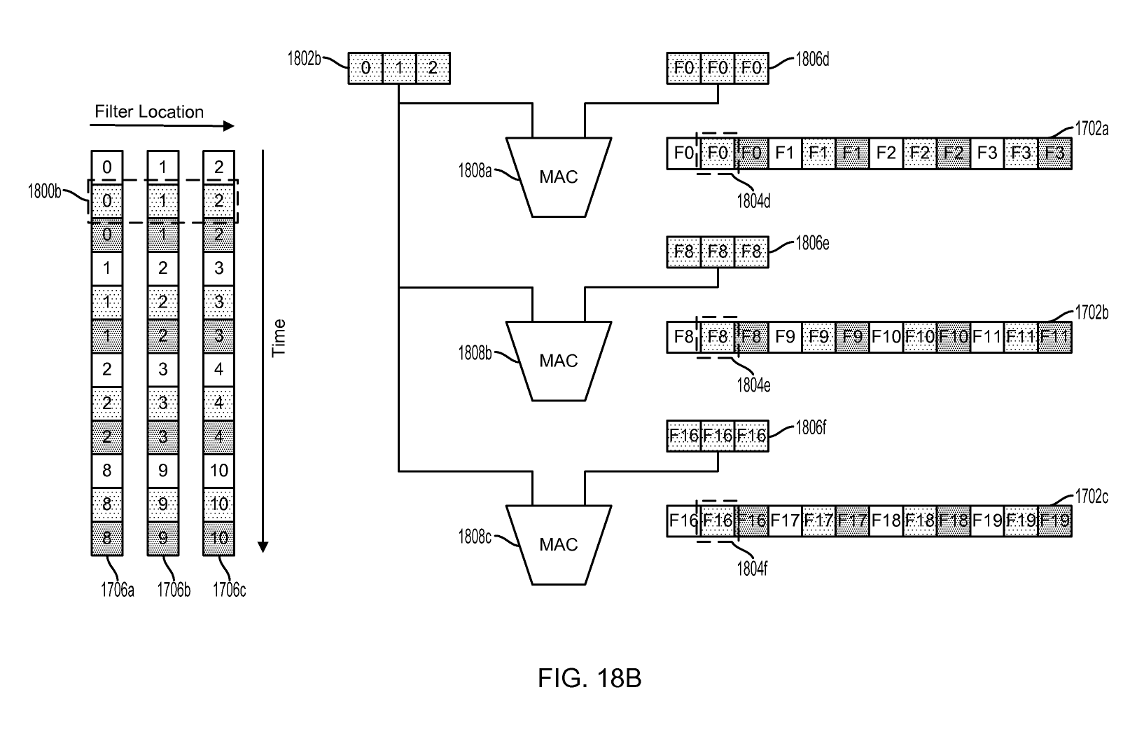

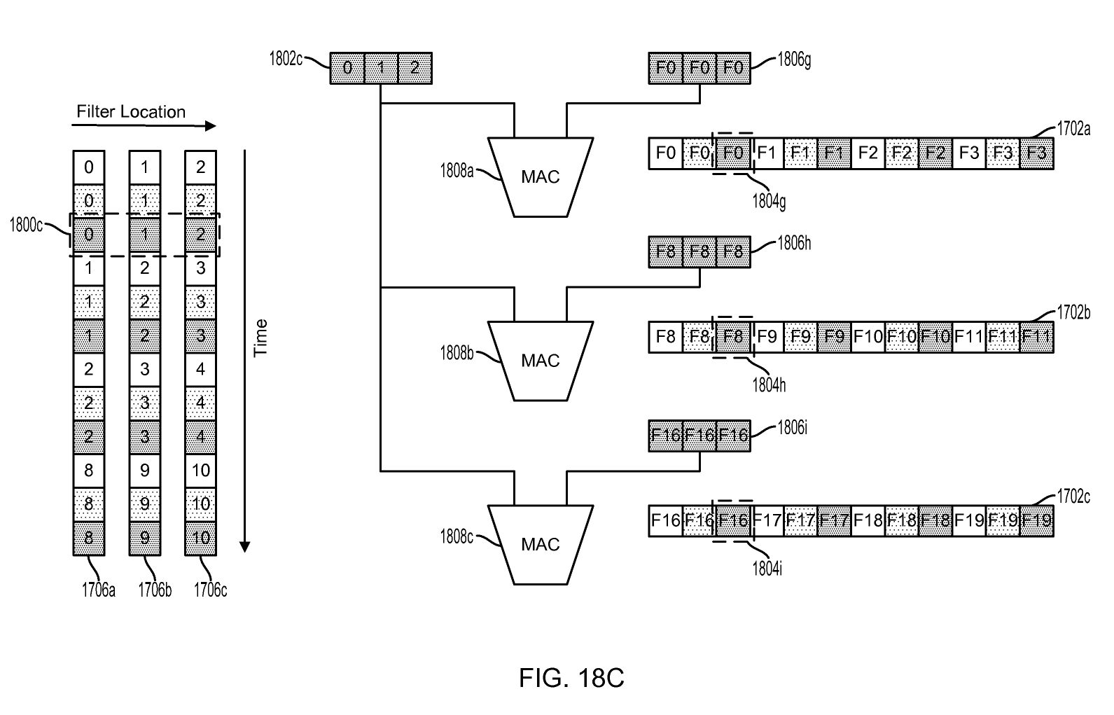

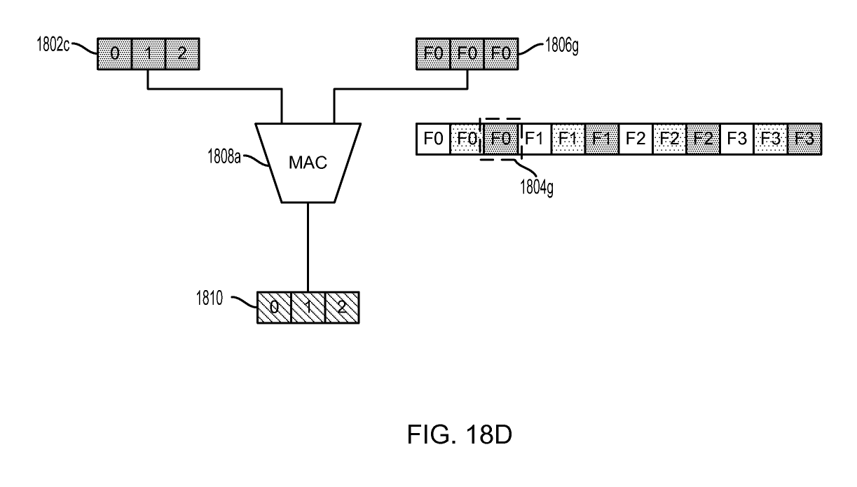

FIGS. 18A-18D illustrate an example of a process flow for generating a pre-partial output using a kernel and feature vector. This is only an example and not limiting in any manner, particularly with respect to the size, number, configuration, or content of the raw data, feature vectors, and kernels (or weight factors). FIGS. 18A-18D illustrates implementation of an operation using three vector units, such as multiply-accumulate (MAC) units 1808 (e.g., 1808a-1808c).

FIG. 18A shows the implementation of the operation using filtered data 1800a and a feature vector 1802a at a first time. The filter data 1800a may represent the data in various locations of the respective filter queues 1702 of the multiply-accumulate units 1808 (e.g., filter queue 1702a of multiply-accumulate unit 1808a; filter queue 1702b of multiply-accumulate unit 1808b; and filter queue 1702c of multiply-accumulate unit 1808c). In particular, the filter data 1800a may represent the data at the top of the respective filter queues 1702 for the first time (e.g., filter location F0 1804a of filter queue 1702a; filter location F8 1804b of filter queue 1702b; and filter location F16 1804c of filter queue 1702c). At the first time, the multiply-accumulate units 1808 may use the feature queue 1802a and the kernels (or weight factors) of the respective filters 1806 for each of the multiply-accumulate units 1808 (e.g., filter 1806a of multiply-accumulate unit 1808a; filter 1806b of multiply-accumulate unit 1808b; and filter 1806c of multiply-accumulate unit 1808c) to execute the operation.

Each filter 1808 may correspond to a particular filter location 1804 in the filter queue 1702 of the corresponding multiply-accumulate unit 1808 (e.g., filter location F0 1804a for the filter queue 1702a and for filter 1808a; filter location F8 1804b for the filter queue 1702b and for filter 1808b; and filter location F16 1804c for the filter queue 1702c and for filter 1808c). The kernels (or weight factors) of the respective filters 1806 may correspond to the data at the particular filter location 1804 in the filter queue 1702 of the corresponding multiply-accumulate unit 1808. At the first time the operation may use data from the unshaded data channel.

Similarly, FIG. 18B illustrates the implementation of the operation using filtered data 1800b and a feature vector 1802b at a second time. At the second time the operation may use data from the stippled data channel. Each multiply-accumulate unit 1808 may have its respective filter 1806 with kernel (or weight factor) values that may correspond to the data at the particular filter location 1804 in the filter queue 1702 for the multiply-accumulate unit 1808 (e.g., multiply-accumulate unit 1808a may use the kernel (or weight factor) from filter 1806d corresponding to the data at filter location 1804d of filter queue 1702a; multiply-accumulate unit 1808b may use the kernel (or weight factor) from filter 1806e corresponding to the data at filter location 1804e of filter queue 1702b; and multiply-accumulate unit 1808c may use the kernel (or weight factor) from filter 1806f corresponding to the data at filter location 1804f of filter queue 1702c).

FIG. 18C illustrates the implementation of the operation using filtered data 1800c and a feature vector 1802c at a third time. At the third time the operation may use data from the more heavily stippled data channel. Each multiply-accumulate unit 1808 may have its respective filter 1806 with kernel (or weight factor) values that may correspond to the to the data at the particular filter location 1804 in the filter queue 1702 for the multiply-accumulate unit 1808 (e.g., multiply-accumulate unit 1808a may use the kernel (or weight factor) from filter 1806g corresponding to the data at filter location 1804g of filter queue 1702a; multiply-accumulate unit 1808b may use the kernel (or weight factor) from filter 1806h corresponding to the data at filter location 1804h of filter queue 1702b; and multiply-accumulate unit 1808c may use the kernel (or weight factor) from filter 1806i corresponding to the data at filter location 1804i of filter queue 1702c).

FIG. 18D illustrates an example of a partial output 1810 of one of the multiply-accumulate units 1808 (e.g., 1808a) after executing the operation for the feature vector 1802 and the kernels (or weight factors) of the corresponding filters 1806 for all of the available channels of data. At each time, for each channel of data, the multiply-accumulate units 1808 may store the result of the executed operation and combine it with the other results to produce a partial output 1810, which may be output after the completion of the executions based on certain parameters, including a designated number of executions. In an embodiment, the partial output 1810 may be output to the partial output vector register associated with the multiply-accumulate units 1808.

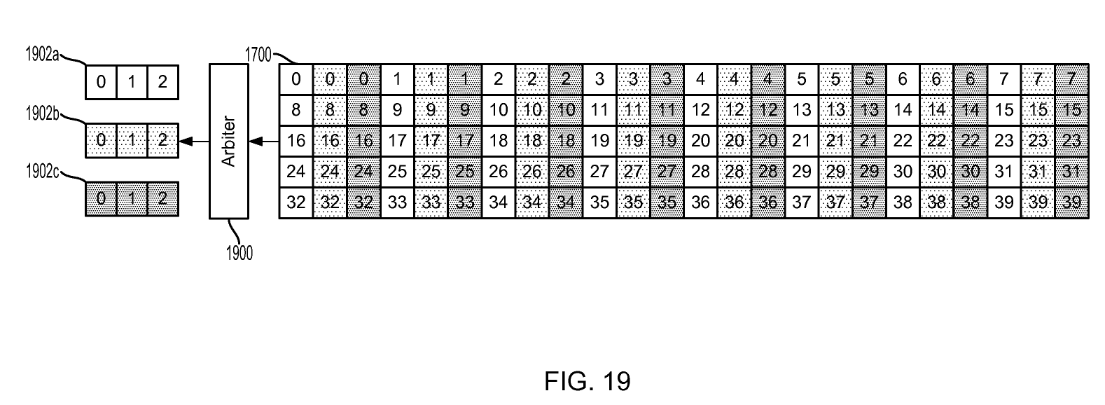

FIG. 19 illustrates an example of a process flow for generating a feature vector using an arbiter to assign addresses to raw data. This is only an example and not limiting in any manner, particularly with respect to the size, number, configuration, or content of the raw data and feature vectors. In this example, the raw data set 1700 may be received by an arbiter 1900, for example via one or more fist-in first-out queues that may read the rows of the raw data set 1700. The arbiter 1900 may assign addresses from multiple feature vectors 1902 (e.g., 1902a-1902c), to each unit of data of the raw data set grouped by data channel. As such, the arbiter 1900 may be used instead of the feature buffers of the machine learning accelerator.

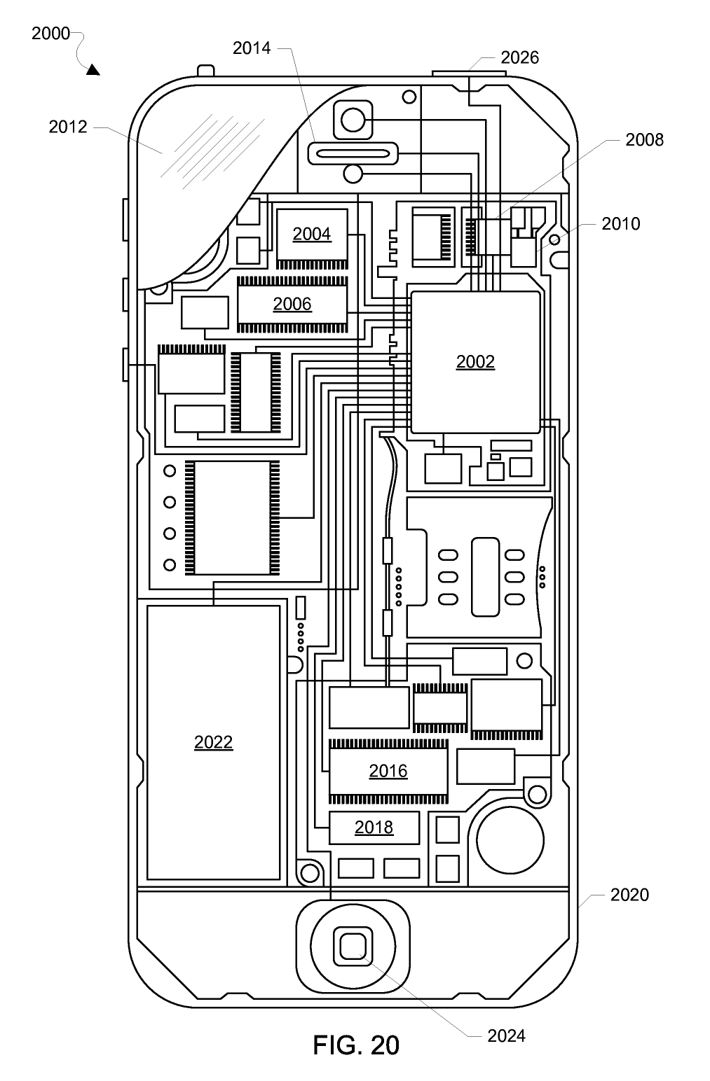

The various embodiments (including, but not limited to, embodiments discussed above with reference to FIGS. 1-19) may be implemented in a wide variety of computing systems, which may include an example mobile computing device suitable for use with the various embodiments illustrated in FIG. 20. The mobile computing device 2000 may include a processor 2002 coupled to a touchscreen controller 2004 and an internal memory 2006. The processor 2002 may be one or more multicore integrated circuits designated for general or specific processing tasks. The internal memory 2006 may be volatile or non-volatile memory, and may also be secure and/or encrypted memory, or unsecure and/or unencrypted memory, or any combination thereof. Examples of memory types that can be leveraged include but are not limited to DDR, LPDDR, GDDR, WIDEIO, RAM, SRAM, DRAM, P-RAM, R-RAM, M-RAM, STT-RAM, and embedded DRAM. The touchscreen controller 2004 and the processor 2002 may also be coupled to a touchscreen panel 2012, such as a resistive-sensing touchscreen, capacitive-sensing touchscreen, infrared sensing touchscreen, etc. Additionally, the display of the computing device 2000 need not have touch screen capability.

The mobile computing device 2000 may have one or more radio signal transceivers 2008 (e.g., Peanut, Bluetooth, Zigbee, Wi-Fi, RF radio) and antennae 2010, for sending and receiving communications, coupled to each other and/or to the processor 2002. The transceivers 2008 and antennae 2010 may be used with the above-mentioned circuitry to implement the various wireless transmission protocol stacks and interfaces. The mobile computing device 2000 may include a cellular network wireless modem chip 2016 that enables communication via a cellular network and is coupled to the processor.

The mobile computing device 2000 may include a peripheral device connection interface 2018 coupled to the processor 2002. The peripheral device connection interface 2018 may be singularly configured to accept one type of connection, or may be configured to accept various types of physical and communication connections, common or proprietary, such as USB, FireWire, Thunderbolt, or PCIe. The peripheral device connection interface 2018 may also be coupled to a similarly configured peripheral device connection port (not shown).

The mobile computing device 2000 may also include speakers 2014 for providing audio outputs. The mobile computing device 2000 may also include a housing 2020, constructed of a plastic, metal, or a combination of materials, for containing all or some of the components discussed herein. The mobile computing device 2000 may include a power source 2022 coupled to the processor 2002, such as a disposable or rechargeable battery. The rechargeable battery may also be coupled to the peripheral device connection port to receive a charging current from a source external to the mobile computing device 2000. The mobile computing device 2000 may also include a physical button 2024 for receiving user inputs. The mobile computing device 2000 may also include a power button 2026 for turning the mobile computing device 2000 on and off.

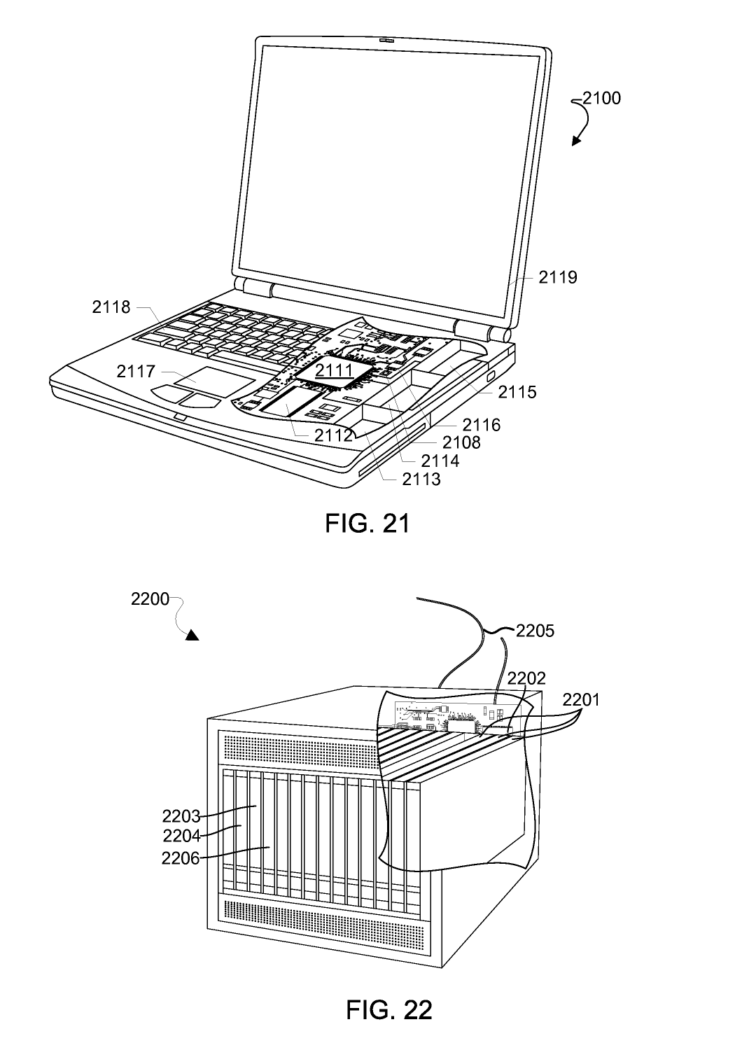

The various embodiments (including, but not limited to, embodiments discussed above with reference to FIGS. 1-19) may be implemented in a wide variety of computing systems, which may include a variety of mobile computing devices, such as a laptop computer 2100 illustrated in FIG. 21. Many laptop computers include a touchpad touch surface 2117 that serves as the computer's pointing device, and thus may receive drag, scroll, and flick gestures similar to those implemented on computing devices equipped with a touch screen display and described above. A laptop computer 2100 will typically include a processor 2111 coupled to volatile memory 2112 and a large capacity nonvolatile memory, such as a disk drive 2113 of Flash memory. Additionally, the computer 2100 may have one or more antenna 2108 for sending and receiving electromagnetic radiation that may be connected to a wireless data link and/or cellular telephone transceiver 2116 coupled to the processor 2111. The computer 2100 may also include a floppy disc drive 2114 and a compact disc (CD) drive 2115 coupled to the processor 2111. In a notebook configuration, the computer housing includes the touchpad 2117, the keyboard 2118, and the display 2119 all coupled to the processor 2111. Other configurations of the computing device may include a computer mouse or trackball coupled to the processor (e.g., via a USB input) as are well known, which may also be used in conjunction with the various embodiments.

The various embodiments (including, but not limited to, embodiments discussed above with reference to FIGS. 1-19) may be implemented in a wide variety of computing systems, which may include any of a variety of commercially available servers for compressing data in server cache memory. An example server 2200 is illustrated in FIG. 22. Such a server 2200 typically includes one or more multi-core processor assemblies 2201 coupled to volatile memory 2202 and a large capacity nonvolatile memory, such as a disk drive 2204. As illustrated in FIG. 22, multi-core processor assemblies 2201 may be added to the server 2200 by inserting them into the racks of the assembly. The server 2200 may also include a floppy disc drive, compact disc (CD) or digital versatile disc (DVD) disc drive 2206 coupled to the processor 2201. The server 2200 may also include network access ports 2203 coupled to the multi-core processor assemblies 2201 for establishing network interface connections with a network 2205, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

Computer program code or “program code” for execution on a programmable processor for carrying out operations of the various embodiments may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of accelerating machine learning on a computing device, comprising:
receiving raw data from a raw data source device;
identifying key features as two dimensional matrices of the raw data such that the key features are mutually exclusive from each other;
translating the key features into key feature vectors;
generating a feature vector from at least one of the key feature vectors;
receiving a first partial output resulting from an execution of a basic linear algebra subprogram (BLAS) operation using the feature vector and a weight factor; and
combining the first partial output with a plurality of partial outputs to produce an output matrix.

2. The method of claim 1, wherein identifying key features as two dimensional matrices of the raw data such that the key features are mutually exclusive from each other comprises:
identifying a first key feature as a first two dimensional matrix of a designated size; and
identifying a second key feature as a second two dimensional matrix of the designated size a designated number of units from the first key feature.

3. The method of claim 1, wherein generating a feature vector from at least one of the key feature vectors comprises:
selecting a top key feature vector from a key feature vector queue; and
using the top key feature vector as the feature vector.

4. The method of claim 1, wherein generating a feature vector from at least one of the key feature vectors comprises:
selecting a top key feature vector from a key feature vector queue;
selecting a next key feature vector from the key feature vector queue;
selecting top key feature vector positions and next key feature vector positions; and
combining the selected top key feature vector position and the selected next key feature vector positions into the feature vector.

5. The method of claim 4, wherein:
selecting top key feature vector positions and next key feature vector positions comprises selecting the top key feature vector positions and the next key feature vector positions such that each of the selected top key feature vector position and the selected next key feature vector positions represent mutually exclusive locations from each other in the raw data and represent an unidentified key feature of raw data that spans a plurality of the identified key features of the raw data; and
combining the selected top key feature vector position and the selected next key feature vector positions into the feature vector comprises combining the selected top key feature vector position and the selected next key feature vector positions into the feature vector such that the feature vector is configured like a key feature vector of the unidentified key feature.

6. The method of claim 1, further comprising:
activating a set of vector units upon receiving the raw data at a feature buffer associated with the set of vector units, wherein the set of vector units is mapped to the output matrix;
executing the BLAS operation by each vector unit of the set of vector units; and
outputting at least one partial output by each vector unit.

7. The method of claim 6, further comprising:
determining whether any feature vectors remain for use in an execution of the BLAS operation by the set of vector units; and
deactivating the set of vector units in response to determining that no feature vectors remain for use in an execution of the BLAS operation by the set of vector units.

8. The method of claim 1, wherein receiving raw data from a raw data source device comprises receiving streaming raw data from the raw data source device.

9. An apparatus configured to accelerate machine learning on a computing device, comprising:
a raw data source device; and
a vectorization unit communicatively connected to the raw data source device, and configured to perform operations comprising:
receiving raw data from the raw data source device;
identifying key features as two dimensional matrices of the raw data such that the key features are mutually exclusive from each other;
translating the key features into key feature vectors;
generating a feature vector from at least one of the key feature vectors;
receiving a first partial output resulting from an execution of a basic linear algebra subprogram (BLAS) operation using the feature vector and a weight factor; and
combining the first partial output with a plurality of partial outputs to produce an output matrix.

10. The apparatus of claim 9, wherein the vectorization unit is configured to perform operations such that identifying key features as two dimensional matrices of the raw data such that the key features are mutually exclusive from each other comprises:
identifying a first key feature as a first two dimensional matrix of a designated size; and
identifying a second key feature as a second two dimensional matrix of the designated size a designated number of units from the first key feature.

11. The apparatus of claim 9, wherein the vectorization unit is configured to perform operations such that generating a feature vector from at least one of the key feature vectors comprises:
selecting a top key feature vector from a key feature vector queue; and
using the top key feature vector as the feature vector.

12. The apparatus of claim 9, wherein the vectorization unit is configured to perform operations such that generating a feature vector from at least one of the key feature vectors comprises:
selecting a top key feature vector from a key feature vector queue;
selecting a next key feature vector from the key feature vector queue;
selecting top key feature vector positions and next key feature vector positions; and
combining the selected top key feature vector position and the selected next key feature vector positions into the feature vector.

13. The apparatus of claim 12, wherein the vectorization unit is configured to perform operations such that:
selecting top key feature vector positions and next key feature vector positions comprises selecting the top key feature vector positions and the next key feature vector positions such that each of the selected top key feature vector position and the selected next key feature vector positions represent mutually exclusive locations from each other in the raw data and represent an unidentified key feature of raw data that spans a plurality of the identified key features of the raw data; and
combining the selected top key feature vector position and the selected next key feature vector positions into the feature vector comprises combining the selected top key feature vector position and the selected next key feature vector positions into the feature vector such that the feature vector is configured like a key feature vector of the unidentified key feature.

14. The apparatus of claim 9, further comprising a set of vector units communicatively connected to the vectorization unit, wherein the set of vector units is mapped to the output matrix, and wherein:
the vectorization unit comprises a feature buffer associated with the set of vector units, and the vectorization unit is configured to execute operations further comprising activating the set of vector units upon receiving the raw data at the feature buffer associated with the set of vector units;
each vector unit of the set of vector units is configured to perform operations comprising:
executing the BLAS operation; and
outputting at least one partial output.

15. The apparatus of claim 14, wherein the vectorization unit is configured to execute operations further comprising:
determining whether any feature vectors remain for use in an execution of the BLAS operation by the set of vector units; and
deactivating the set of vector units in response to determining that no feature vectors remain for use in an execution of the BLAS operation by the set of vector units.

16. The apparatus of claim 9, wherein the vectorization unit is configured to execute operations such that receiving raw data from a raw data source device comprises receiving streaming raw data from the raw data source device.

17. An apparatus configured to accelerate machine learning on a computing device, comprising:
means for receiving raw data from a raw data source device;
means for identifying key features as two dimensional matrices of the raw data such that the key features are mutually exclusive from each other;
means for translating the key features into key feature vectors;
means for generating a feature vector from at least one of the key feature vectors;
means for receiving a first partial output resulting from an execution of a basic linear algebra subprogram (BLAS) operation using the feature vector and a weight factor; and
means for combining the first partial output with a plurality of partial outputs to produce an output matrix.

18. The apparatus of claim 17, wherein means for identifying key features as two dimensional matrices of the raw data such that the key features are mutually exclusive from each other comprises:
means for identifying a first key feature as a first two dimensional matrix of a designated size; and
means for identifying a second key feature as a second two dimensional matrix of the designated size a designated number of units from the first key feature.

19. The apparatus of claim 17, wherein means for generating a feature vector from at least one of the key feature vectors comprises:
means for selecting a top key feature vector from a key feature vector queue; and
means for using the top key feature vector as the feature vector.

20. The apparatus of claim 17, wherein means for generating a feature vector from at least one of the key feature vectors comprises:
means for selecting a top key feature vector from a key feature vector queue;
means for selecting a next key feature vector from the key feature vector queue;
means for selecting top key feature vector positions and next key feature vector positions; and
means for combining the selected top key feature vector position and the selected next key feature vector positions into the feature vector.

21. The apparatus of claim 20, wherein:
means for selecting top key feature vector positions and next key feature vector positions comprises means for selecting the top key feature vector positions and the next key feature vector positions such that each of the selected top key feature vector position and the selected next key feature vector positions represent mutually exclusive locations from each other in the raw data and represent an unidentified key feature of raw data that spans a plurality of the identified key features of the raw data; and
means for combining the selected top key feature vector position and the selected next key feature vector positions into the feature vector comprises means for combining the selected top key feature vector position and the selected next key feature vector positions into the feature vector such that the feature vector is configured like a key feature vector of the unidentified key feature.

22. The apparatus of claim 17, further comprising:
means for executing the BLAS operation;
means for outputting at least one partial output, wherein means for executing the BLAS operation and means for outputting at least one partial output are mapped to the output matrix;
means for activating means for executing the BLAS operation and means for outputting the at least one partial output upon receiving the raw data;
means for determining whether any feature vectors remain for use in an execution of the BLAS operation; and
means for deactivating means for executing the BLAS operation and means for outputting the at least one partial output in response to determining that no feature vectors remain for use in an execution of the BLAS operation.

23. The apparatus of claim 17, wherein means for receiving raw data from a raw data source device comprises means for receiving streaming raw data from the raw data source device.

24. A non-transitory processor-readable storage medium having stored thereon processor-executable instructions configured to cause a processor of a computing device to perform operations comprising:
receiving raw data from a raw data source device;
identifying key features as two dimensional matrices of the raw data such that the key features are mutually exclusive from each other;
translating the key features into key feature vectors;
generating a feature vector from at least one of the key feature vectors;
receiving a first partial output resulting from an execution of a basic linear algebra subprogram (BLAS) operation using the feature vector and a weight factor; and
combining the first partial output with a plurality of partial outputs to produce an output matrix.

25. The non-transitory processor-readable storage medium of claim 24, wherein the stored processor-executable instructions are configured to cause the processor to perform operations such that identifying key features as two dimensional matrices of the raw data such that the key features are mutually exclusive from each other comprises:
identifying a first key feature as a first two dimensional matrix of a designated size; and
identifying a second key feature as a second two dimensional matrix of the designated size a designated number of units from the first key feature.

26. The non-transitory processor-readable storage medium of claim 24, wherein the stored processor-executable instructions are configured to cause the processor to perform operations such that generating a feature vector from at least one of the key feature vectors comprises:
selecting a top key feature vector from a key feature vector queue; and
using the top key feature vector as the feature vector.

27. The non-transitory processor-readable storage medium of claim 24, wherein the stored processor-executable instructions are configured to cause the processor to perform operations such that generating a feature vector from at least one of the key feature vectors comprises:
selecting a top key feature vector from a key feature vector queue;
selecting a next key feature vector from the key feature vector queue;
selecting top key feature vector positions and next key feature vector positions; and
combining the selected top key feature vector position and the selected next key feature vector positions into the feature vector.

28. The non-transitory processor-readable storage medium of claim 27, wherein the stored processor-executable instructions are configured to cause the processor to perform operations such that:
selecting top key feature vector positions and next key feature vector positions comprises selecting the top key feature vector positions and the next key feature vector positions such that each of the selected top key feature vector position and the selected next key feature vector positions represent mutually exclusive locations from each other in the raw data and represent an unidentified key feature of raw data that spans a plurality of the identified key features of the raw data; and
combining the selected top key feature vector position and the selected next key feature vector positions into the feature vector comprises combining the selected top key feature vector position and the selected next key feature vector positions into the feature vector such that the feature vector is configured like a key feature vector of the unidentified key feature.

29. The non-transitory processor-readable storage medium of claim 24, wherein the stored processor-executable instructions are configured to cause the processor to perform operations further comprising:
activating the processor upon receiving the raw data, wherein the processor is mapped to the output matrix;
executing the BLAS operation;
outputting at least one partial output;
determining whether any feature vectors remain for use in an execution of the BLAS operation by the processor; and
deactivating the processor in response to determining that no feature vectors remain for use in an execution of the BLAS operation by the processor.

30. The non-transitory processor-readable storage medium of claim 24, wherein the stored processor-executable instructions are configured to cause the processor to perform operations such that receiving raw data from a raw data source device comprises receiving streaming raw data from the raw data source device.
